(19) United States
(12) Patent Application Publication
(10) Pub. No.: US 2003/0084284 A1
(43) Pub. Date: May 1, 2003

(54) Data distribution system, sending device, receiving device, data distribution method, sending method, receiving method, recording medium on which data preparation program is recorded and recording medium on which data assembling program is recorded

(76) Inventors: Satoshi Ando, Munakata-Gun (JP); Kazuhide Sawabe, Katano (JP); Yuji Shimizu, Koga (JP)

Correspondence Address: WENDEROTH, LIND & PONACK, L.L.P., 2033 K STREET N. W., SUITE 800, WASHINGTON, DC, 20006-1021, US

(21) Appl. No.: 10/274,993

(22) Filed: Oct. 22, 2002

(30) Foreign Application Priority Data
Oct. 24, 2001 (JP) 2001-325982

(51) Int. Cl. H04L 9/00

(52) U.S. Cl. 713/163

(57) ABSTRACT

The invention comprises a data dividing unit for dividing input data into a plurality of pieces, a divided data replicating unit for replicating divided data, an additional information embedding unit for embedding additional information into replicated data, an encrypting unit for encrypting the data embedded with the additional information, and a sending unit for sending the encrypted data by means of multicast communications, further comprises a decoding unit for decoding the encrypted data which is received, and an assembling unit for assembling the decoded data.

### BACKGROUND OF THE INVENTION

1. Field of the Invention

The present invention relates to a data distribution system for distributing electronic data to a plurality of receiving devices by using a network and related arts thereof.

2. Description of the Related Art

First, general unicast communications and multicast communications will be explained.

FIG. 19 is a view for explaining general unicast communications and multicast communications. FIG. 19(a) is a view for explaining unicast communications. FIG. 19(b) is a view for explaining multicast communications.

As shown in FIG. 19(a), in general unicast communications, when the same data D is distributed to the three receiving devices, a sending device prepares the same three pieces of data D and sends the data to the network thereby distributing the data to the three receiving devices.

On the other hand, as shown in FIG. 19(b), in general multicast communications, when the same data D is distributed to the three receiving devices, the sending device prepares a piece of data D and sends the data to the network. Then, this data D is replicated on the network to be distributed to the three receiving devices.

In the case where the same data is distributed to a plurality of receiving devices, multicast communications are appropriate, but the pieces of data distributed in this case must be exactly the same.

### OBJECTS AND SUMMARY OF THE INVENTION

Problems in the case where encrypted data is distributed by means of the prior art are explained.

FIG. 20 is a view for explaining problems in the case where the encrypted data is distributed by means of the prior art.

As shown in FIG. 20(a), the sending device prepares a piece of data D and subjects the data D to encryption processing with an encryption key K. Furthermore, an “*” denotes encrypting.

Then, this encrypted data D*K is distributed to three receiving devices by means of multicast communications.

In this manner, in the case where the same data distributed to the three receiving devices is subjected to the same encrypting, since multicast communications can be performed, the bandwidth for the transmission can be reduced.

However, in this case, since the encryption key is commonly used for the data D distributed to the three receiving devices, there arises a problem in that the security of the data is not necessarily superior.

Then, as shown in FIG. 20(b), the sending device prepares the same three pieces of data and subjects the same three pieces of data D to the encryption processing with three different encryption keys Ka, Kb and Kc.

Then, the three pieces of data D*Ka, D*Kb, D*Kc which are subjected to encryption processing are distributed to the three receiving devices by means of unicast communications. In this case, since the encryption keys are different, the security of the data is superior.

However, in this case, since the sending device encrypts the same three pieces of data D with three different encryption keys, there arises a problem in that the load of encryption processing becomes large.

Furthermore, in this case, since the sending device encrypts the same three pieces of data D with different encryption keys, there arises a problem in that multicast communications cannot be performed, and the bandwidth cannot be reduced.

Next, explained is a problem in the case where data embedded with additional information is distributed by means of the prior art. The additional information refers to electronic watermark information (for example, see Japanese Unexamined Patent Publication No. 2001-285274, or Japanese Unexamined Patent Publication No. 11-069137).

FIG. 21 is a view for explaining a problem in the case where data embedded with the additional information is distributed by means of the prior art.

As shown in FIG. 21(a), the sending device prepares a piece of data D, and a piece of additional information W is embedded into this data D. Furthermore, “+” means that the additional information is embedded therein.

Then, the data D+W embedded with this additional information W is distributed to the three receiving devices by means of multicast communications.

In this manner, in the case where the same additional information W is embedded into the same data distributed to the three receiving devices, multicast communications can be performed, so that the bandwidth for sending the data can be reduced.

However, in this case, since the additional information embedded with the data D which is distributed to the three receiving devices is common, there arises a problem in that the prior art is not always superior from the viewpoint of identification of the secondary distribution source.

Then, as shown in FIG. 21(b), the sending device prepares the same three pieces of data D and embeds three different pieces of additional information Wa, Wb, and We in the same data D.

Then, three pieces of data D+Wa, D+Wb and D+Wc embedded with the three different pieces of additional information Wa, Wb and We are distributed to three receiving devices by means of unicast communications. In this case, the technique is superior from the viewpoint of identification of the secondary distribution source.

However, in this case, since the sending device embeds different pieces of additional information in the same three pieces of data D, there arises a problem in that the load of this processing becomes large.

Furthermore, since the sending device embeds different pieces of additional information in the same three pieces of data D, there arises a problem in that multicast communications cannot be performed, and the bandwidth cannot be reduced.

Next, there will be explained a problem in the case where the data which is subjected to embedding processing of the additional information and encryption processing is distributed by means of the prior art.

FIG. 22 is a view for explaining a problem in the case where the data which is subjected to embedding processing of the additional information and encryption processing is distributed by means of the conventional method.

As shown in FIG. 22(a), the sending device prepares a piece of data D, and a piece of additional information W is embedded in this data D to prepare a piece of data D+W.

Then, the sending device replicates this one piece of data D+W to prepare the same three pieces of data D+W, and the same three pieces of data D+W are subjected to encryption processing by means of three different encryption keys Ka, Kb and Kc.

Then, the three pieces of data (D+W)*Ka, (D+W)*Kb, and (D+W)*Kc which are subjected to encryption processing are distributed to the three receiving devices by means of unicast communications.

In this case, although the security of the data is superior because the encryption keys are different, there arises a problem in that the technique is not always superior from the viewpoint of identification of the secondary distribution source because the additional information to be embedded is common.

Furthermore, in this case, since the sending device encrypts the same three pieces of data D+W with different encryption keys, there arises a problem in that the load of encryption processing becomes large.

Furthermore, in this case, since the sending device encrypts the same three pieces of data D+W with different encryption keys, there arises a problem in that multicast communications cannot be performed, and the bandwidth cannot be reduced.

Furthermore, in FIG. 22(b), the sending device prepares the same three pieces of data D and embeds three different pieces of additional information Wa, Wb and Wc in the same three pieces of data D.

Then, the sending device subjects three pieces of data D+Wa, D+Wb, and D+Wc embedded with three different pieces of additional information Wa, Wb and Wc to encryption processing with an encryption key K, and thereby the three pieces of data (D+Wa)*K, (D+Wb)*K, and (D+Wc)*K are obtained.

These three pieces of data (D+Wa)*K, (D+Wb)*K and (D+Wc)*K are distributed to the three receiving devices by means of unicast communications.

In this case, although the technique is superior from the viewpoint of identification of the secondary distribution source since the additional information to be embedded is different, there arises a problem in that the security of the data is not necessarily superior because the encryption key is common.

Furthermore, in this case, since the sending device embeds different pieces of additional information to the same three pieces of data D, there arises a problem in that the load of the processing becomes large.

Furthermore, in this case, since the sending device embeds different pieces of additional information to the same three pieces of data D, there arises a problem in that multicast communications cannot be performed, and the bandwidth cannot be reduced.

Furthermore, in FIG. 22(c), the sending device prepares the same three pieces of data D, and embeds three different pieces of additional information Wa, Wb and Wc in the same three pieces of data D.

Then, the sending device subjects the three pieces of data D+Wa, D+Wb and D+Wc embedded with three different pieces of additional information Wa, Wb and Wc to encryption processing with three different encryption keys Ka, Kb and Kc, and thereby three pieces of data (D+Wa)*Ka, (D+Wb)*Kb and (D+Wc)*Kc are obtained.

These three pieces of data (D+Wa)*Ka, (D+Wb)*Kb and (D+Wc)*Kc are distributed to three receiving devices by means of unicast communications.

In this case, since the additional information to be embedded and the encryption keys are different, the technique is extremely superior from the viewpoint of identification of the secondary distribution source. Moreover, the security of the data is also superior since the encryption keys are different.

Furthermore, in FIG. 22(b), since the same decoding key is given to the three receiving devices, the possibility that the decoding key is stolen becomes high. When the decoding key is stolen, the identification of the secondary distribution source naturally becomes difficult. Therefore in this point, the example of FIG. 22(c) is far superior from the viewpoint of identification of the secondary distribution source.

However, in the case of FIG. 22(c), since the sending device subjects the same three pieces of data D to embedding processing of different pieces of additional information and encryption processing with different encryption keys, there arises a problem in that the load of the processing becomes large.

Furthermore, in this case, since the sending device subjects the same three pieces of data D to embedding processing of the different pieces of additional information and encryption processing with different encryption keys, there arises a problem in that multicast communications cannot be performed and the bandwidth cannot be reduced.

Next, explained by citing concrete examples is a problem in the case where the data is distributed which has been subjected to embedding processing of different pieces of additional information and encryption processing with different encryption keys by means of the prior art.

FIG. 23 is a view for explaining a problem in the case where data is distributed which has been subjected to embedding processing of different pieces of additional information and encryption processing with different encryption keys by means of the prior art.

In FIG. 23, there is cited an example in which data is distributed to each of eight users U1 through U8. These eight users U1 through U8 have receiving devices, respectively, and the data is transmitted to the receiving devices.

Then, the sending device prepares the same eight pieces of data D and embeds different pieces of additional information W1 through W8 to prepare eight pieces of data D+W1 through D+W8. Then, the sending device encrypts eight pieces of data D+W1 through D+W8 with eight different encryption keys K1 through K8 to prepare eight pieces of data E1 through E8.

The sending device sends these eight pieces of data E1 through E8 to eight receiving devices of eight users U1 through U8.

The receiving device of the user U1 receives the data E1, and decodes the data with a decoding key K1. Furthermore, “/” means that the data is decoded. The receiving devices of other users U2 through U8 also decode data in the same manner.

As has been explained above, in the case where the data which has been embedded with different pieces of additional information and encrypted with different encryption keys is distributed, multicast communications cannot be performed, and the bandwidth for sending cannot be reduced.

Furthermore, it is required to perform embedding processing of the additional information with respect to eight pieces of data. Furthermore, encryption processing must be performed with respect to eight pieces of data. Consequently, the load of such processing becomes large in the sending device.

Next, the above-mentioned problems will be summarized.

In the case where different pieces of additional information are embedded in the same data, and the data is distributed to a plurality of receiving devices, the load of embedding processing of additional information increases. Furthermore, in this case, multicast communications cannot be performed, and the bandwidth for data distribution cannot be reduced.

In the case where the same data is subjected to encryption processing with different encryption keys, and the data is distributed to a plurality of receiving devices, the load of encryption processing increases. Furthermore, in this case, multicast communications cannot be performed, and the bandwidth for the data distribution cannot be reduced.

In the case where the same data is subjected to embedding processing of different pieces of additional information and encryption processing with different encryption keys, and the data is distributed to a plurality of receiving devices, the load of embedding processing of additional information and encryption processing increases. Furthermore, in this case, multicast communications cannot be performed, and the bandwidth for the data distribution cannot be reduced.

The load of embedding processing of additional information and encryption processing and the bandwidth required for the data distribution that have been described above increase in proportion to the number of receiving devices (users) for distributing the data.

On the other hand, in order to reduce the bandwidth required for data distribution, there is a method of performing one-to-many communications by means of multicast communications or broadcast communications or the like. In the conventional method by means of multicast communications or broadcast communications or the like, embedding processing of different pieces of additional information and encryption processing with different encryption keys cannot be performed respectively for different receiving devices (users).

Consequently, an object of the present invention is to provide a data distribution system, which can perform embedding processing of different pieces of additional information and encryption processing with different encryption keys with respect to the same data which is distributed to the receiving devices while suppressing the load of embedding processing of additional information and encryption processing and an increase in the bandwidth required for distributing data, and related arts thereof.

The data distribution system according to a first aspect of the present invention has a sending device for distributing data by means of broadcast communications or multicast communications by using a network and a plurality of receiving devices for receiving the data distributed by the sending device.

The above-mentioned sending device is composed of a data dividing unit for dividing input data into a plurality of pieces, a divided data replicating unit for replicating data divided by the above-mentioned data dividing unit, an encrypting unit for encrypting a plurality of pieces of data having the same content including data replicated by the above-mentioned divided data replicating unit, and a sending unit for sending the data encrypted by the above-mentioned encrypting unit to the above-mentioned network.

Each of the above-mentioned receiving devices is composed of a receiving unit for receiving the above-mentioned data sent by the above-mentioned sending unit to the network, a decoding unit for decoding the above-mentioned data received by the above-mentioned receiving unit, and an assembling unit for assembling the data decoded by the above-mentioned decoding unit.

With this structure, the data input to the sending device is divided and replicated. Thereafter, the data is encrypted and distributed by means of broadcast communications or multicast communications.

As a consequence, the same data can be subjected to encryption processing with different encryption keys for each of the receiving devices for distributing data while suppressing the load of encryption processing and an increase in the bandwidth required for data distribution.

The data distribution system according to a second aspect of the present invention has a sending device for distributing data by means of broadcast communications or multicast communications by using a network, and a plurality of receiving devices for receiving the data distributed by the sending device.

The above-mentioned sending device is composed of a data dividing unit for dividing input data into a plurality of pieces, a divided data replicating unit for replicating data divided by the above-mentioned data dividing unit, an additional information embedding unit for embedding different pieces of additional information in a plurality of pieces of data having the same content including the data replicated by the above-mentioned divided data replicating unit, and a sending unit for sending the data embedded with the above-mentioned additional information by the above-mentioned additional information embedding unit to the above-mentioned network.

Each of the above-mentioned receiving devices is composed of a receiving unit for receiving the above-mentioned data sent by the above-mentioned sending unit to the above-mentioned network, and an assembling unit for assembling the above-mentioned data received by the above-mentioned receiving unit.

With this structure, the data input to the sending device is divided and replicated. Thereafter, the data is subjected to embedding processing of the additional information, and is distributed by means of broadcast communications or multicast communications.

As a consequence, the same data can be subjected to embedding processing of different pieces of additional information for each of the receiving devices for distributing data while suppressing the load of embedding processing of the additional information and an increase in the bandwidth required for data distribution.

The data distribution system according to a third aspect of the present invention has a sending device for distributing data by means of broadcast communications or multicast communications by using a network, and a plurality of receiving devices for receiving the data distributed by the sending device.

The above-mentioned sending device is composed of a data dividing unit for dividing input data into a plurality of pieces, and a divided data replicating unit for replicating data divided by the data dividing unit, an additional information embedding unit for embedding different pieces of additional information in a plurality of pieces of data having the same content including data replicated by the above-mentioned divided data replicating unit, an encrypting unit for encrypting the data embedded with the above-mentioned additional information by means of the above-mentioned additional information embedding unit, and a sending unit for sending the data encrypted by the encrypting unit to the above-mentioned network.

Each of the above-mentioned receiving devices is composed of a receiving unit for receiving the above-mentioned data sent by the above-mentioned sending unit to the above-mentioned network, a decoding unit for decoding the above-mentioned data received by the above-mentioned receiving unit, and an assembling unit for assembling the data decoded by the above-mentioned decoding unit.

With this structure, the data input to the sending device is divided and replicated. Subsequently, the data is subjected to embedding processing of additional information and encryption processing, and is distributed by means of broadcast communications or multicast communications.

As a consequence, the same data can be subjected to embedding processing of different pieces of additional information and encryption processing with different encryption keys for each of the receiving devices for distributing the data while suppressing the load of embedding processing of additional information and encryption processing and an increase in the bandwidth required for the data distribution.

The data distribution system according to a fourth aspect of the present invention comprises, in addition to the first, the second, and the third aspects of the invention, the sending device comprising a data type classification unit for classifying a plurality of types of input data into types, and outputting the data of a predetermined type to the data dividing unit.

With this structure, the data of the type which is arbitrarily selected out of the plurality of types of data can be subjected to encryption processing and embedding processing of the additional information.

Consequently, it becomes possible to provide a flexible response even in the case where it is not required to subject all the types of data to the encryption processing and embedding processing of the additional information.

Furthermore, if only a specific type of data out of the plurality of types of data is subjected to encryption processing and processing of embedding the additional information, an increase in the load of embedding processing of additional information and encryption processing can be further suppressed and an increase in the bandwidth required for data distribution can be further suppressed.

The above, and other objects, features and advantages of the present invention will become apparent from the following description read in conjunction with the accompanying drawings, in which like reference numerals designate the same elements.

### BRIEF DESCRIPTION OF THE DRAWINGS

FIG. 1 is a block diagram of an exemplary data distribution system according to Embodiment 1 of the present invention.

FIG. 2 is a flowchart of an exemplary sending device of the same.

FIG. 3 is a flowchart of an exemplary receiving device of the same.

FIG. 4 is a block diagram of an exemplary data distribution system according to Embodiment 2 of the present invention.

FIG. 5 is a flowchart of an exemplary sending device of the same.

FIG. 6 is a block diagram of an exemplary data distribution system according to Embodiment 3 of the present invention.

FIG. 7 is a flowchart of an exemplary sending device of the same.

FIG. 8 is a view for illustrating a processing in the sending device of the same.

FIG. 9 is a view for illustrating an exemplary decoding processing in a receiving device of the same.

FIG. 10(a) is a view for illustrating decoded data in the receiving device of the same.

FIG. 10(b) is a view for illustrating assembled data in the receiving device of the same.

FIG. 10(c) is a view for illustrating an additional information extraction processing.

FIG. 10(d) is a view for illustrating extracted additional information.

FIG. 11 is a view for illustrating a processing in the sending device of the same.

FIG. 12 is a view for illustrating a data sending channel in the case where multicast communications are performed by the sending device of the same.

FIG. 13 is a view for illustrating a processing in the receiving device of the same in the case where multicast communications are performed with the sending device of the same.

FIG. 14 is a view for illustrating a sending channel of data in the case where broadcast communications are performed with the sending device of the same.

FIG. 15 is a view for explaining a processing of the receiving device of the same in the case where broadcast communications are performed with the sending device of the same.

FIG. 16 is a block diagram of an exemplary data write and readout system in Embodiment 4 of the present invention.

FIG. 17 is a block diagram of an exemplary data write and readout system in Embodiment 5 of the present invention.

FIG. 18 is a block diagram of an exemplary data write and readout system in Embodiment 6 of the present invention.

FIG. 19(a) is a view for explaining data distribution by means of general unicast communications.

FIG. 19(b) is a view for explaining data distribution by means of general multicast communications.

FIG. 20(a) is a view for explaining a problem in the case where data encrypted with the same encryption key is distributed by a prior art.

FIG. 20(b) is a view for explaining a problem in the case where data encrypted with the different encryption keys is distributed by a prior art.

FIG. 21(a) is a view for explaining a problem in the case where data embedded with the same additional information is distributed by a prior art.

FIG. 21(b) is a view for explaining a problem in the case where data embedded with different pieces of additional information are distributed by a prior art.

FIG. 22(a) is a view for explaining a problem in the case where data embedded with the same additional information and encrypted with different encryption keys is distributed by a prior art.

FIG. 22(b) is a view for explaining a problem in the case where data embedded with different pieces of additional information and encrypted with the same encryption key is distributed by a prior art.

FIG. 22(c) is a view for explaining a problem in the case where data embedded with different pieces of additional information and encrypted with different encryption keys is distributed by a prior art.

FIG. 23 is a view for explaining a problem in the case where data subjected to embedding processing of additional information and encryption processing is distributed by a prior art.

### DETAILED DESCRIPTION OF THE PREFERRED EMBODIMENTS

Hereinafter, embodiments of the present invention will be explained by referring to the drawings. In the embodiment, data is distributed by means of multicast communications or broadcast communications.

Broadcast communications is a communications method for distributing data to all nodes on a network.

Multicast communications is a communications method for distributing data to a specific node or specific nodes on the network. Multicast communications is a kind of broadcast communications.

(Embodiment 1)

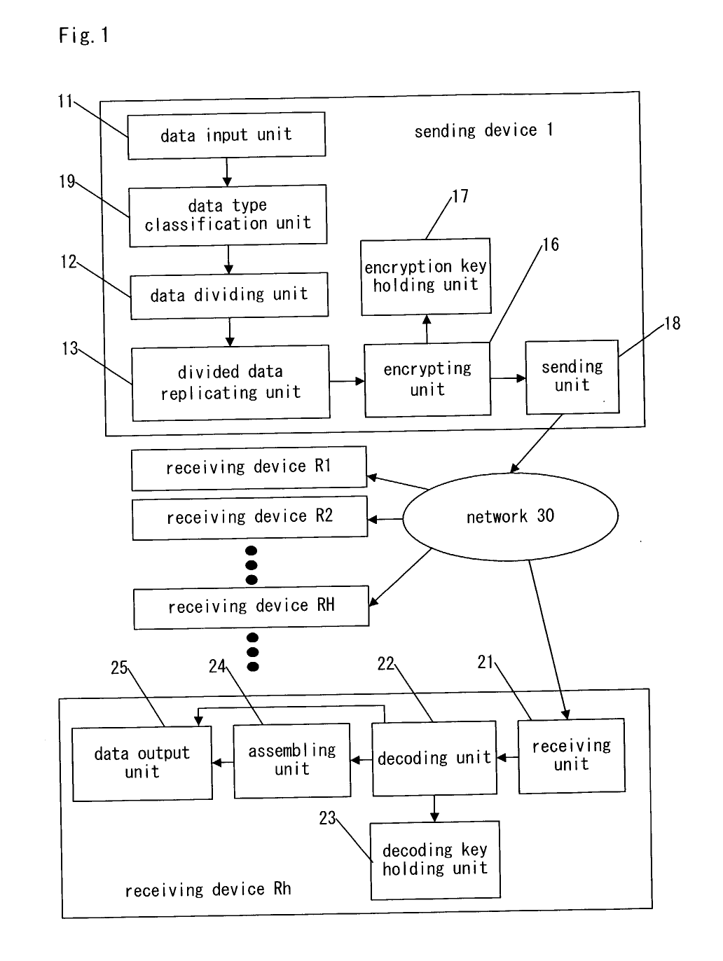

FIG. 1 is a block diagram of an exemplary data distribution system in Embodiment 1 of the present invention. As shown in FIG. 1, this data distribution system has a sending device 1 and a plurality of receiving devices R1, R2, . . . , RH, . . . (collectively referred to as “Rh”).

These devices are connected to a network 30. As an example of the network 30, a LAN, the Internet or the like can be given.

The sending device 1 is composed of a data input unit 11, a data type classification unit 19, a data dividing unit 12, a divided data replicating unit 13, an encrypting unit 16, an encryption key holding unit 17, and a sending unit 18.

The receiving device Rh is composed of a receiving unit 21, a decoding unit 22, a decoding key holding unit 23, an assembling unit 24 and a data output unit 25.

Next, the operation of each structure will be explained. First, the sending device 1 will be explained.

The data input unit 11 inputs data to be sent. The data type classification unit 19 classifies the input data for each type, the data of the type which is to be divided is output to the data dividing unit 12.

The data dividing unit 12 divides the data output by the data type classification unit 19 into a plurality of pieces so as to prepare divided data.

Here, the division of data made by the data dividing unit 12 means the time division of the data.

The divided data replicating unit 13 replicates a part or the entirety of the divided data prepared by the data dividing unit 12 so as to prepare replicated data.

The encryption key holding unit 17 holds encryption keys required for encryption of data. The encrypting unit 16 encrypts the replicated data prepared by the divided data replicating unit 13 by means of the encryption keys obtained from the encryption key holding unit 17 and thereby prepares encrypted data.

The sending unit 18 distributes the encrypted data prepared by the encrypting unit 16 to the plurality of receiving devices Rh by means of multicast communications or broadcast communications by using the network 30.

Next, the receiving device Rh will be explained.

The receiving unit 21 receives the encrypted data distributed by the sending unit 18. The decoding key holding unit 23 holds decoding keys required for the decoding of the data.

The decoding unit 22 subjects the encrypted data received by the receiving unit 21 to the decoding processing by means of the decoding keys obtained from the decoding key holding unit 23 thereby prepares decoded data.

The encrypted data which has not been decoded is not output to the assembling unit 24, and the decoding unit 22 discards the data.

The assembling unit 24 assembles the decoded data prepared by the decoding unit 22. The data output unit 25 outputs the data assembled by the assembling unit 24.

Furthermore, in the case where the receiving unit 21 receives the divided data which has not been encrypted and gives the unencrypted data to the decoding unit 22, the decoding unit 22 does not perform the decoding processing, and the unencrypted divided data is output to the assembling unit 24. The assembling unit 24 assembles the divided data.

Furthermore, in the case where the receiving unit 21 receives data which is neither divided nor encrypted and the data is given to the decoding unit 22, the decoding unit 22 outputs the data to the data output unit 25 without performing the decoding processing. Then, the data output unit 25 outputs the data.

Next, explained in detail is the data dividing unit 12 and the divided data replicating unit 13. The number of divisions by the data dividing unit 12 is set to 2 or more. The number of divisions may be any number as long as it is two or more.

The number of replications by the divided data replicating unit 13 with respect to a piece of divided data is set to 2 or more. The number of replications may be any number as long as it is two or more.

Here, the number of divisions by the data dividing unit 12 is set to “m” while the number of replications with respect to a piece of divided data by the divided data replicating unit 13 is set to “n”.

In the case where the entirety of the replicated data is encrypted with different encryption keys, the number of combinations of the encryption keys becomes (m-th power of n).

Consequently, the data encrypted with different encryption keys can be distributed to (m-th power of n) receiving devices (users).

Furthermore, in this case, the bandwidth required for the data distribution can be limited to a range of n times or less as compared with the case in which the data given to the data dividing unit 12 by the data type classification unit 19 is encrypted and transmitted.

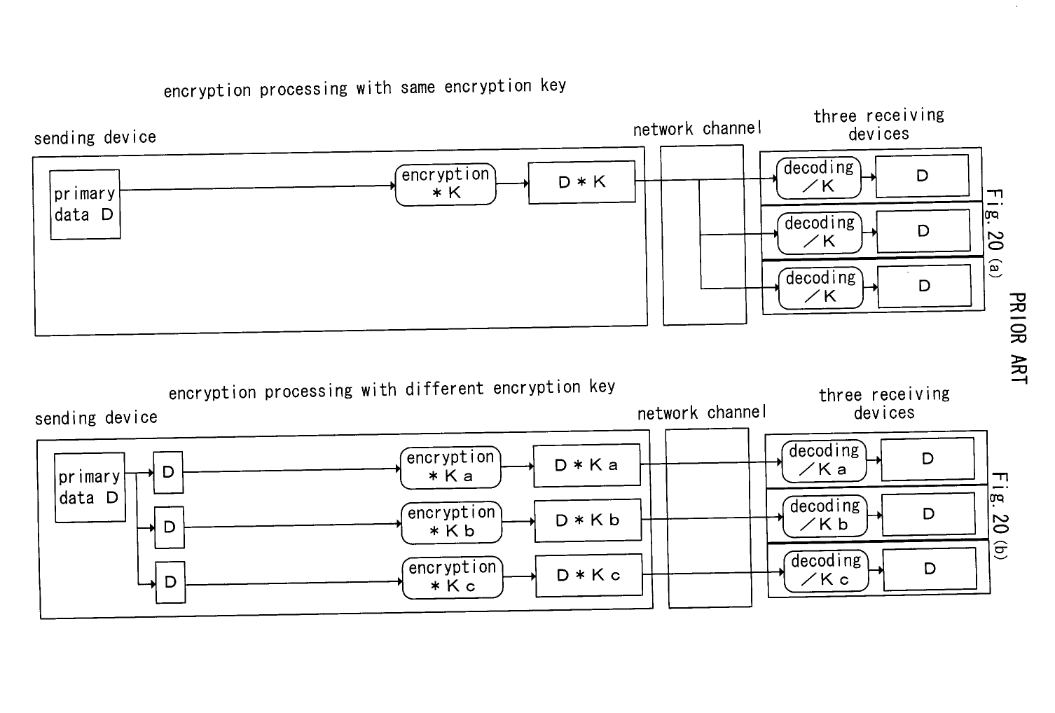

Furthermore, in this case, the bandwidth required for the data distribution becomes ((1−m)-th power of n) times as compared with the case (see FIG. 20(b)) in which the data encrypted with different encryption keys is distributed to the (m-th power of n) receiving devices (users) by unicast communications, so that the bandwidth can be reduced.

Furthermore, in this case, the load of encryption processing becomes ((1−m)-th power of n) times as compared with the case (see FIG. 20(b)) in which the data encrypted with different encryption keys is distributed by means of unicast communications, so that the load can be reduced. This point will be explained in detail.

In this embodiment, since the data is divided into m pieces in the direction of time, and the resulted data is replicated n times and subjected to encryption processing, the processing number becomes (n×m). On the other hand, the processing number with the conventional method becomes (m-th power of n).

Since the encryption processing is performed for the entirety of the data, the load of encryption processing stands proportional to the data length. In this embodiment, the average of the data length in one processing is 1/m of the original data. On the other hand, the data length is the same as that of the original data in the conventional method.

Consequently, the load of encryption processing in the present embodiment becomes (original data length)×(1/m)×(n×m).

On the other hand, the load of encryption processing in the conventional method becomes (original data length)×(m-th power of n).

Consequently, the load of encryption processing in the embodiment becomes n/(m-th power of n)=((1−m)-th power of n) times as compared with the conventional method.

The above-mentioned point will be explained by giving concrete examples.

Suppose that the number of the divisions is set to m=3, and the number of replications is set to n=2. In the case where the entirety of the replicated data is encrypted with different encryption keys, the number of combinations of the encryption keys becomes the third power of two, namely, eight.

Consequently, data which is encrypted with different encryption keys can be distributed to eight receiving devices (eight users).

Furthermore, in this case, the bandwidth required for the data distribution can be limited to a range of two times as compared with the case in which the data itself input by the data input unit II is encrypted and transmitted.

Furthermore, in this case, the bandwidth required for the data distribution becomes ((1−3)-th power of 2) times, namely, ¼ times as compared with the case in which the data encrypted with different encryption keys is distributed to eight receiving devices (eight users) by means of unicast communications, so that the bandwidth can be reduced.

Furthermore, in this case, the load of encryption processing becomes ((1−3)-th power of 2) times, namely, ¼ times as compared with the case in which the data encrypted with different encryption keys is distributed to eight receiving devices (eight users) by means of unicast communications, so that the load can be reduced.

Furthermore, suppose that the number of divisions is set to m=8 and the number of replications is set to n=10. In the case where the entirety of the replicated data is encrypted with different encryption keys, the number of combinations of encryption keys becomes 100000000 (eighth power of 10).

Consequently, the data encrypted with different encryption keys can be distributed to 100000000 receiving devices (100000000 users).

Furthermore, in this case, the bandwidth required for data distribution can be limited to a range of 10 times as compared with the case in which the data input by the data input unit 11 is encrypted and distributed.

Furthermore, in this case, the bandwidth required for data distribution becomes (1−8)-th power of 10) times, namely, 1/10000000 times as compared with the case in which the data encrypted with different encryption keys is distributed to 100000000 receiving devices by means of unicast communications, so that the bandwidth can be reduced.

Furthermore, in this case, the load of encryption processing becomes (1−8)-th power of 10) times, namely, 1/10000000 times as compared with the case in which the data encrypted with different encryption keys is distributed to 100000000 receiving devices (100000000 users) by means of unicast communications, so that the load can be reduced.

Furthermore, in the case where the divided data is prepared by the data dividing unit 12, the length of the divided data can be arbitrarily set. Furthermore, in the case where a piece of data is divided and a plurality of divided pieces of data are prepared, the length of each of the divided pieces of data can be made different.

Furthermore, the encrypting by the encrypting unit 16 can be performed with respect to all the types of data. Furthermore, it is not necessarily required to perform the encrypting of all the types of data.

For example, with respect to audio video image data, the type of data is of three types; video image data, right side audio data and left side audio data.

Consequently, in this case, with respect to all three types of data, division by the data dividing unit 12, replication by the divided data replicating unit 13 and encrypting by the encrypting unit 16 may be performed.

Furthermore, with respect to one or two types of data out of the three, dividing processing by the data dividing unit 12, replicating processing by the divided data replicating unit 13, and encryption processing by the encrypting unit 16 may be performed whereas these processings may not be performed with respect to the rest of the types of data.

Furthermore, since dividing processing, replicating processing and encryption processing can be independently performed for each type of data, it is not necessary to set to the same level the number of divisions, the length of divided data and the number of replications.

For example, in the case where dividing processing, replicating processing and encryption processing are performed with respect to all three types of data in an example of the above-mentioned audio video image data, it is not required to set to the same level the number of divisions, the length of divided data and the number of replications with the video image data, the right side audio data and left side audio data.

Next, a flow of processing in the exemplary sending device 1 in the present embodiment will be explained by use of a flowchart.

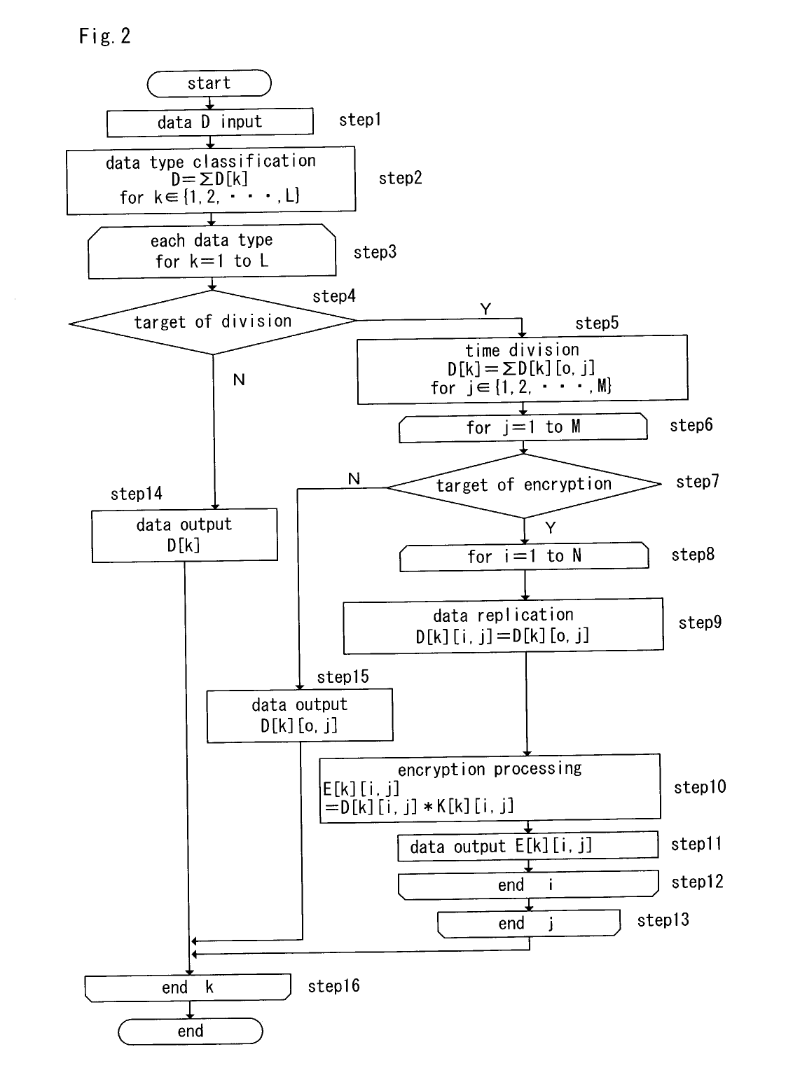

FIG. 2 is a flowchart of the sending device 1 according to the present embodiment. As shown in FIG. 2, at step 1, the data input unit 11 inputs the data D.

Next, at step 2, the data type classification unit 19 classifies the input data D into types. “k” in FIG. 2 is a symbol for identifying the type of data (hereinafter referred to as “data type number”). Furthermore, in the case where, for example, the input data D is the audio video image data, the data is composed of the video image data, the right side audio data, and the left side audio data. Thus, in FIG. 2, L=3 is given.

Hereinafter, explained is a case in which the audio video image data D is input by giving an example. Then, a target of division by the data dividing unit 12 is set as the left side audio data in the three types of data composing the audio video image data D.

Next, the processing from step 4 to step 15 will be performed for each of the data type (step 3 and step 16).

At step 4, the data type classification unit 19 judges as to whether the data type is the target of division. Then, when the data type is the target of division, the data is output to the data dividing unit 12 to proceed to step 5.

Furthermore, it can be arbitrarily set as to which type of data is set as the target of division by the data dividing unit 12.

In the above-mentioned example, the data type classification unit 19 outputs the left side audio data D[k] to the data dividing unit 12 in the case where the type of data is the left side audio data.

Next, at step 5, the data dividing unit 12 divides the left side audio data D[k] to prepare a plurality of divided data D[k] [0, j]. Here, “j” of FIG. 2 denotes a number for identifying the divided data (hereinafter, referred to as “time division number”). Furthermore, for example, in the case where the number of divisions is set to three, M=3 is given in FIG. 2. Furthermore, numeral “0” in the divided data D[k] [0, j] means that the number of replications at this point in time is “0”.

Next, the processing from step 7 to step 12 is repeated from j=1 up to j=M. (step 6 and step 13).

At step 7, the data divided unit 12 judges as to whether the divided data D[k] [0, j] are targets of encryption.

Then, when the data dividing unit 12 judges that the divided data D[k] [0, j] are not targets of encryption, the divided data D[k] [0, j] are output to the sending unit 18 at step 15.

On the other hand, in the case where the data dividing unit 12 judges that the divided data D[k] [0, j] are targets of encryption, the divided data D[k] [0, j] are output to the divided data replicating unit 13 to proceed to step 8.

Next, the processing from step 9 to step 11 is repeated from i=1 up to i=N (step 8 and step 12). “i” denotes a number for identifying the replicated data (hereinafter referred to as “replication number”). For example, in the case where the number of replications is two, N=2 is given.

At step 9, the divided data replicating unit 13 replicates the divided data D[k] [0, j] so as to prepare the replicated data D[k] [i, j].

Next, at step 10, the encrypting unit 16 encrypts the replicated data D[k] [i, j] with encryption key K[k] [i, j] so as to prepare encrypted data E[k] [i, j]. Furthermore, “*” in FIG. 2 means encryption.

Next, at step 11, the encrypting unit 16 outputs the encrypted data E[k] [i, j] to the sending unit 18.

Furthermore, at step 4, when the data type classification unit 19 judges that the type of data is not the target of division, the data type classification unit 19 outputs the data D[k] to the sending unit 18 at step 14.

In the above-mentioned example, in the case where the type of data is the video image data and the right side audio data, the data type classification unit 19 outputs these data D[k] to the sending unit 18.

Next, a processing flow in the receiving device Rh in the present embodiment will be explained by use of a flowchart.

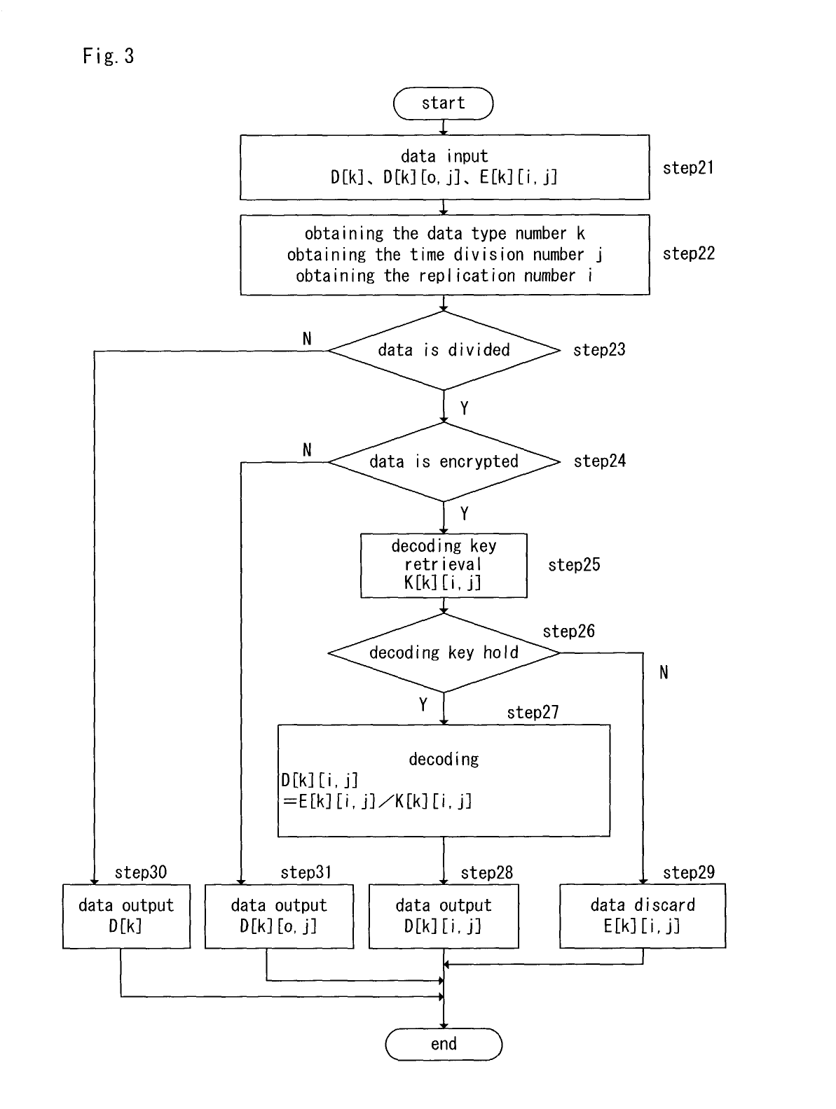

FIG. 3 is a flowchart of the exemplary receiving device Rh in the present embodiment.

As shown in FIG. 3, at step 21, the data D[k], the data D[k] [0, j] and the data D[k] [i, j] are input to the decoding unit 22 from the receiving unit 21.

Next, at step 22, the decoding unit 22 obtains the data type number k, the time division number j and replication number i from the input data.

Next, at step 23, the decoding unit 22 judges on the basis of the data type number k that the input data is divided data prepared by the data dividing unit 12.

When the data is not divided data, the decoding unit 22 outputs the data D[k] to the data output unit 25 at step 30. On the other hand, when the data is divided data, the process proceeds to step 24.

In the above-mentioned example, if the input data is the left side audio data, the process proceeds to step 24.

Next, the decoding unit 22 judges on the basis of the replication number i that the divided data is the encrypted data prepared by the encrypting unit 16.

When the data is not encrypted data, the decoding unit 22 outputs the divided data D[k] [0, j] to the assembling unit 24 at step 31. Then, the divided data D[k] [0, j] are assembled with the assembling unit 24. On the other hand, when the data is encrypted data, the process proceeds to step 25. Furthermore, in the case where the replication number i is “0”, it means that the data is not encrypted (see step 7 of FIG. 2).

Next, at step 25, the decoding unit 22 retrieves the decoding key K[k] [i, j], which can decode the encrypted data, from the decoding key holding unit 23.

Next, at step 26, in the case where the decoding key holding unit 23 does not hold the decoding key K[k] [i, j] which can decode the encrypted data, the decoding unit 22 discards the data E[k] [i, j] at step 29.

On the other hand, in the case where the decoding key holding unit 23 holds the decoding key K[k] [i, j] which can decode the encrypted data, the decoding unit 22 proceeds to step 27.

Next, at step 27, the decoding unit 22 decodes the encrypted data E[k] [i, j] with an appropriate decoding key K[k] [i, j] so as to obtain the decoded data D[k] [i, j]. Moreover, “/” in FIG. 3 means decoding.

Next, at step 28, the decoding unit 22 outputs the decoded data D[k] [i, J] to the assembling unit 24. Then, the decoded data D[k] [i, j] are assembled with the assembling unit 24.

Then, the process returns to FIG. 1. As mentioned above, the number of replications n in the divided data replicating unit 13 was set to 2 or more.

This is because all the data which is set as the target of encryption in the encrypting unit 16 is prepared as the replicated data.

However, as targets of encryption in the encrypting unit 16, the replicated data and the divided data can also be used. The divided data is original for the replicated data.

In this case, the number of replications n may be one or more. By doing so, the sum total of the replicated data and the original divided data always become two or more.

Here, the number of divisions by the data dividing unit 12 is set to “m”, the number of replications by the divided data replicating unit 13 is set to “n” and the sum total of the replicated data and the original divided data are set to “p”. Thus, p=n+1 is given.

In the case where all the replicated data and all the original divided data are encrypted with different encryption keys, the number of combinations of the encryption keys becomes the m-th power of p.

Consequently, the data encrypted with different encryption keys can be distributed to (m-th power of p) receiving devices (users).

Furthermore, in this case, the bandwidth required for the data distribution can be limited to a range of p times as compared with the case in which the data input by the data input unit 11 is encrypted and distributed.

Furthermore, in this case, the bandwidth required for the data distribution becomes ((1−m)-th power of p) times as compared with the case in which the data encrypted with different encryption keys is distributed to the (m-th power of p) receiving devices (users) by means of unicast communications, so that the bandwidth can be reduced.

Furthermore, in this case, the load of encryption processing becomes ((1−m)-th power of p) as compared with the case in which the data encrypted with different encryption keys is distributed to (m-th power of p) receiving devices (users) by means of unicast communications, so that the load can be reduced.

Furthermore, as has been described above, in the present embodiment, the data input from the data input unit 11 of the sending device 1 is subjected to dividing processing by the data dividing unit 12 and replication processing by the divided data replicating unit 13, and thereafter encrypted by the encrypting unit 16 so as to be distributed by means of multicast communications or broadcast communications by the sending unit 18.

As a consequence, the encryption processing can be performed with different encryption keys to the same data for each of the receiving devices for distributing data while suppressing the load of encryption processing and an increase in the bandwidth required for the data distribution.

That is, unlike the case in which the same data is subjected to encryption processing with different encryption keys for each of the receiving devices for distributing data so as to be distributed by means of unicast communications, the load of encryption processing does not increase and the bandwidth required for data distribution does not increase in proportion to the number of receiving devices for distributing data.

Furthermore, the data type classification unit 19 classifies data composed of a plurality of types of input data into types and outputs the data of the type which is set in advance as the target of division to the data dividing unit 12.

As a consequence, the data of the type which is arbitrarily selected out of the plurality of types of data can be subjected to encryption processing.

Therefore, it is possible to provide a flexible response even in the case where all the types of data are not necessarily subjected to encryption processing.

Furthermore, when only the specific type of data is subjected to encryption processing out of the plurality of types of data, an increase in the load of encryption processing can be suppressed, and an increase in the bandwidth required for data distribution can be further suppressed.

For example, with respect to the audio video image data, it is considered that only one or two types of data are encrypted out of the video image data, the right side audio data and the left side audio data.

(Embodiment 2)

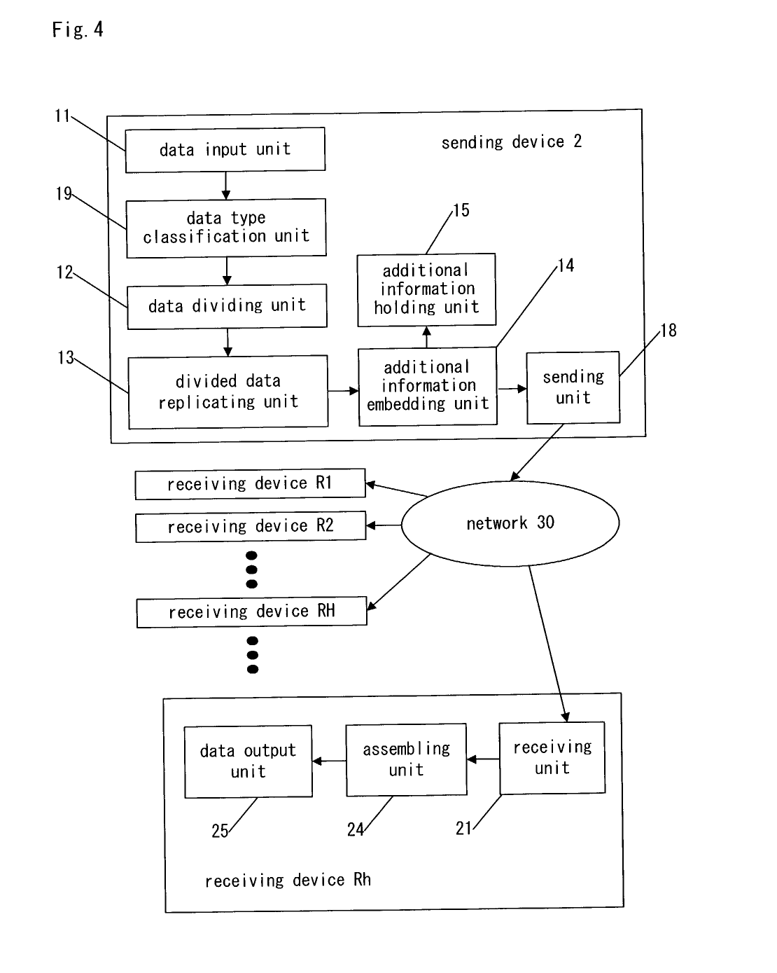

FIG. 4 is a block diagram showing an exemplary data distribution system according to Embodiment 2 of the present invention. In FIG. 4, the same parts as in FIG. 1 are denoted by the same reference numerals and explanations thereof are appropriately omitted.

As shown in FIG. 4, this data distribution system has a sending device 2 and a plurality of receiving devices R1, R2, . . . , RH, . . . (collectively referred to as “Rh”). These devices are connected to a network 30.

The sending device 2 is provided with a data input unit 11, a data type classification unit 19, a data dividing unit 12, a divided data replicating unit 13, an additional information embedding unit 14, an additional information holding unit 15 and a sending unit 18.

The receiving device Rh is composed of a receiving unit 21, an assembling unit 24 and a data output unit 25.

Next, the operation of each structure will be explained. First, a sending device 2 will be explained.

The data input unit 11 inputs data to be sent. The data type classification unit 19 classifies the input data for each type, the data of the type which is to be divided is output to the data dividing unit 12.

The data dividing unit 12 divides the data output by the data type classification unit 19 into a plurality of pieces so as to prepare divided data. Furthermore, the division of data made by the data dividing unit 12 means the time division of the data. The divided data replicating unit 13 replicates a part or the entirety of the divided data prepared by the data dividing unit 12 so as to prepare replicated data.

The additional information holding unit 15 holds additional information which will be embedded into the replicated data. The additional information embedding unit 14 embeds the additional information obtained from the additional information holding unit 15 into the replicated data prepared by the divided data replicating unit 13 so as to prepare additional information embedded data. As an example of the additional information to be embedded, electronic watermark information can be given.

Then, for example, the electronic watermark information includes identification information for identifying a user, identification information for identifying a receiving device, identification information for identifying the original data which has been distributed, information indicating distribution time of the data, and information indicating the handling condition of the data (the presence or absence of the replication limitation, replication limitation time, and the like), and a combination of the above-mentioned each piece of information.

The sending unit 18 distributes the additional information embedded data prepared by the additional information embedding unit 14 to the plurality of receiving devices Rh by means of multicast communications or broadcast communications by using the network 30.

Next, the receiving devices Rh will be explained.

The receiving unit 21 receives the additional information embedded data distributed by the sending unit 18. The assembling unit 24 assembles the additional information embedded data received by the receiving unit 21. The data output unit 25 outputs data assembled by the assembling unit 24.

Furthermore, in the case where the receiving unit 21 receives undivided data and the data is not given to the assembling unit 24, the assembling unit 24 outputs the undivided data to the data output unit 25. Then, the data output unit 25 outputs the data.

Next, explained in detail is the data dividing unit 12 and the divided data replicating unit 13. The number of divisions by the data dividing unit 12 is set to 2 or more. The number of divisions may be any number as long as it is two or more.

The number of replications by the divided data replicating unit 13 with respect to a piece of divided data is set to 2 or more. The number of replications may be any number as long as it is two or more.

Here, the number of divisions by the data dividing unit 12 is set to “m” while the number of replications with respect to a piece of divided data by the divided data replicating unit 13 is set to “n”.

In the case where different pieces of additional information are embedded into the entirety of the replicated data, the number of combinations of additional information becomes (m-th power of n).

Therefore, the data embedded with different pieces of additional information can be distributed to (m-th power of n) receiving devices (users).

Furthermore, in this case, the bandwidth required for the data distribution can be limited to a range of n times or less as compared with the case in which data given to the data dividing unit 12 by the data type classification unit 19 is embedded with different pieces of additional information and transmitted.

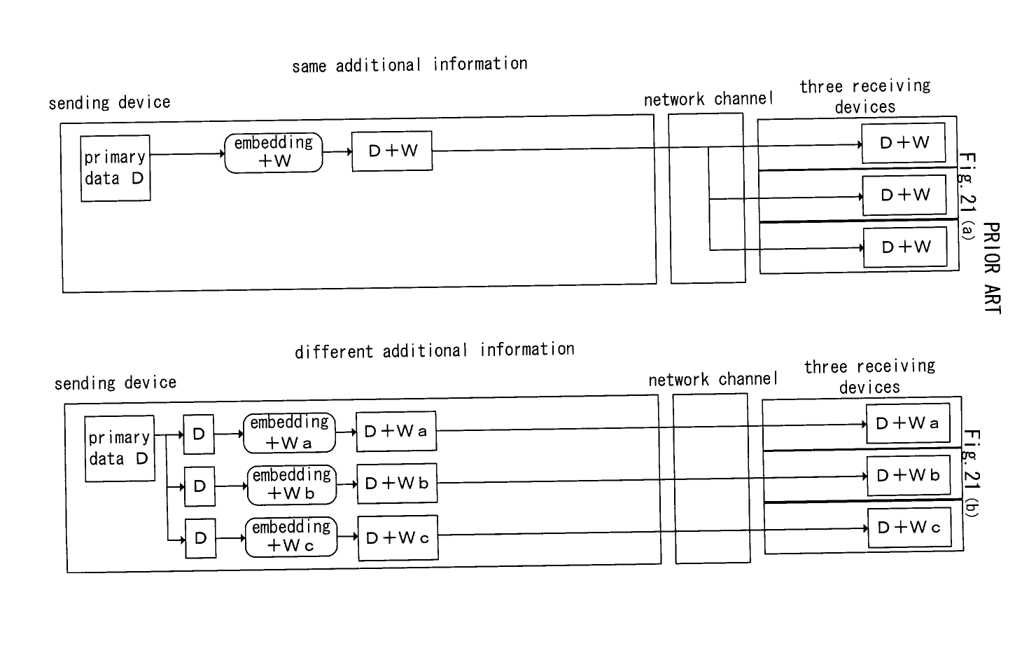

Furthermore, in this case, the bandwidth required for the data distribution can be limited to a range of ((1−m)-th power of n) times as compared with the case in which data embedded with different pieces of additional information are distributed to (m-th power of n) receiving devices (users) by means of unicast communications (see FIG. 21(b)) so that the bandwidth can be reduced.

Furthermore, in this case, the load of embedding processing of the additional information becomes ((1−m)-th power of n) times as compared with the case in which the data embedded with different pieces of additional information are distributed by means of unicast communications to (m-th power of n) receiving devices (users) (see FIG. 21(b)), so that the load can be reduced.

Furthermore, in the case where the divided data is prepared by the data dividing unit 12, the length of the divided data can be arbitrarily set. Furthermore, in the case where a piece of data is divided so as to prepare a plurality of divided data, the length of each piece of the divided data can be made different.

Furthermore, embedding of the additional information with the additional information embedding unit 14 can be performed with respect to all the types of data. Additionally, it is not necessary to embed the additional information with respect to all the types of data.

For example, with respect to audio video image data, the type of data is of three types; video image data, right side audio data and left side audio data.

Consequently, in this case, with respect to all three types of data, division by the data dividing unit 12, replication by the divided data replicating unit 13, and embedding of the additional information by the additional information embedding unit 14 may be performed.

Furthermore, with respect to one or two types of data out of the three, dividing processing by the data dividing unit 12, replicating processing by the divided data replicating unit 13, and embedding of the additional information by the additional information embedding unit 14 may be performed whereas these processings may not be performed with respect to the rest of the types of data.

Furthermore, since dividing processing, replication processing and additional information embedding processing can be independently performed for each type of data, the number of divisions, the length of divided data, and the number of replications are not required to be set to the same level with respect to all types of data.

For example, in an example of the above-mentioned audio video image data, when dividing processing, replication processing and additional information embedding processing are performed with respect to all three types of data, the number of divisions, the length of divided data, and the number of replications are not required to be set to the same level.

Next, a flow of processing in the sending device 2 according to the embodiment will be explained by use of a flowchart.

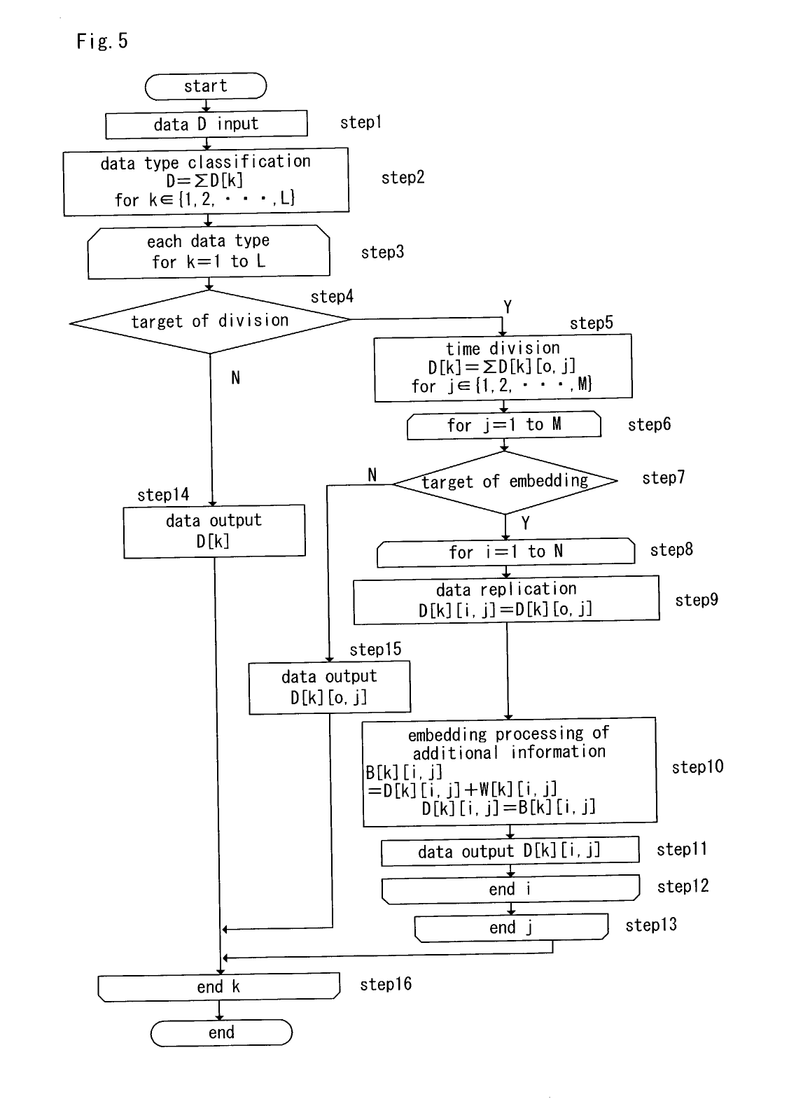

FIG. 5 is a flowchart of an exemplary sending device 2 according to the embodiment. As shown in FIG. 5, at step 1, the data input unit 11 inputs data D.

Next, at step 2, the data type classification unit 19 classifies the input data D into types. “k” of FIG. 5 is a number (data type number) for identifying the type of data. Furthermore, for example, in the case where the input data D is the audio video image data, the data is composed of three types such as the video image data, the right side audio data and the left side audio data. In FIG. 5, L=3 is given.

Hereinafter, an explanation is made by citing as an example a case in which such audio video image data D is input. Then, a target of division by the data dividing unit 12 is set to be the left side audio data in three types of data which constitute the audio video image data D.

Next, processing from step 4 to step 15 is performed for each type of data (step 3 and step 16).

At step 4, the data type classification unit 19 judges as to whether or not the type of data is the target of division. Then, when the type of data is the target of division, the data is output to the data dividing unit 12 to proceed to step 5.

In the above-mentioned example, the data type classification unit 19 outputs the left side audio data D[k] to the data dividing unit 12 in the case where the type of data is the left side audio data.

Next, at step 5, the data dividing unit 12 divides the left side audio data D[k] so as to prepare a plurality of divided data D[k] [0, j]. Here, “j” of FIG. 5 is a number (time division number) for identifying the divided data. Furthermore, for example, in the case where the number of divisions is three, in FIG. 5, M=3 is given. Furthermore, “0” in the divided data D[k] [0, j] means that the number of replications at this point is “0”.

Next, the processing from step 7 to step 12 is repeated from j=1 up to j=M (step 6 and step 13).

At step 7, the data dividing unit 12 judges as to whether or not the divided data D[k] [0, j] are targets of embedding processing of additional information.

Then, the data dividing unit 12 outputs, at step 15 the divided data D[k] [0, j] to the sending unit 18 in the case where the data dividing unit 12 judges that the divided data D[k] [0, j] are not targets of embedding processing of the additional information.

On the other hand, the data dividing unit 12 outputs the divided data D[k] [0, j] to the divided data replicating unit 13 to proceed to step 8 in the case where the data dividing unit 12 judges that the divided data D[k] [0, j] are targets of embedding processing of additional information.

Next, the processing from step 9 to step 11 is repeated from i=1 up to i=N (step 8 and step 12). “i” is a number (replication number) for identifying the replicated data. For example, when the number of replications is two, N=2 is given.

At step 9, the divided data replicating unit 13 replicates the divided data D[k] [0, j] so as to prepare the replicated data D[k] [i, j].

Next, at step 10, the additional information embedding unit 14 embeds the additional information W[k] [i, j] into the replicated data D[k] [i, j] so as to prepare the additional information embedded data B[k] [i, j]. Subsequently, the additional information embedding unit 14 sets D[k] [i, j]=B[k] [i, j]. Furthermore, “+” means that the additional information is embedded.

Next, at step 11, the additional information embedding unit 14 outputs the additional information embedded data D[k] [i, j] to the sending unit 18.

Furthermore, when the data type classification unit 19 judges, at step 4, that the type of data is not the target of division, the data type classification unit 19 outputs the data D[k] to the sending unit 18 at step 14.

In the above-mentioned example, the data type classification unit 19 outputs these pieces of data D[k] to the sending unit 18 in the case where the type of data is the video image data or the right side audio data.

Furthermore, in the same manner as encryption processing by the encrypting unit 16 according to Embodiment 1, the replicated data and the original divided data can be used as targets of embedding processing of additional information by the additional information embedding unit 14.

Furthermore, as described above, in the present embodiment, the data input from the data input unit 11 of the sending device 2 is subjected to dividing processing by the data dividing unit 12 and replication processing by the divided data replicating unit 13. Subsequently, the data is embedded with the additional information by the additional information embedding unit 14, and is distributed by multicast communications or broadcast communications.

As a consequence, while the load of embedding processing of additional information and an increase in the bandwidth required for the data distribution are suppressed, different pieces of additional information can be embedded into the same data for each of the receiving devices for distributing data.

That is, the load of embedding processing of additional information is not increased and the bandwidth required for the data distribution is not increased in proportion to the number of receiving devices for distributing the data unlike the case in which different pieces of additional information are embedded into the same data and is distributed by unicast communications for each of the receiving devices for distributing data.

Furthermore, the data type classification unit 19 classifies the data composed of a plurality of types of input data, and outputs the data of the type which is predetermined as the target of division to the data dividing unit 12.

Because of this, it becomes possible to subject the data of the type which is arbitrarily selected out of the data which is composed of a plurality of types to the embedding processing of additional information.

Consequently, it becomes possible to take a flexible response even in the case in which it is not required to subject all the types of data to the embedding processing of additional information.

Furthermore, when only a specific type of data is subjected to embedding processing of additional information out of a plurality of types of data, both an increase in the load of embedding processing of additional information and an increase in the bandwidth required for the data distribution can be suppressed.

For example, in the case of the audio video image data, it is considered that only one type or two types of data out of the video image data, the right side audio data and the left side audio data are embedded with additional information.

(Embodiment 3)

As has been described above, as an example of the additional information to be embedded into the data, the electronic watermark information is available.

Then, for example, the electronic watermark information includes identification information for identifying a user, identification information for identifying a receiving device, identification information for identifying the distributed original data, information indicating distribution time of the data, information indicating the handling condition of the data (the presence or absence of the replication limitation, replication limitation time or the like), and a combination of the above-mentioned each piece of information.

An object of the electronic water mark is to specify the user of the leak source, namely, the secondary distribution source, in a case where data is leaked from the user who has received the data to a third party.

Consequently, the electronic watermark information, even when the data origin thereof is the same, is required to be different from each of the users. In order to completely specify the leak source, the data embedded with the electronic watermark information and the user are required to stand in a one-to-one correspondence relationship with each other while leakage and wire-tapping of the data on the sending channel must be prevented.

Consequently, in order to distribute electronic data without damaging the object of the electronic watermark information, it is necessary to embed electronic watermark information different from each of the users into the data and encrypt the data embedded with the electronic watermark information so that the data is not leaked to a third party to distribute to each of the users.

According to the present embodiment, both embedding processing of additional information and encryption processing are performed with respect to input data.

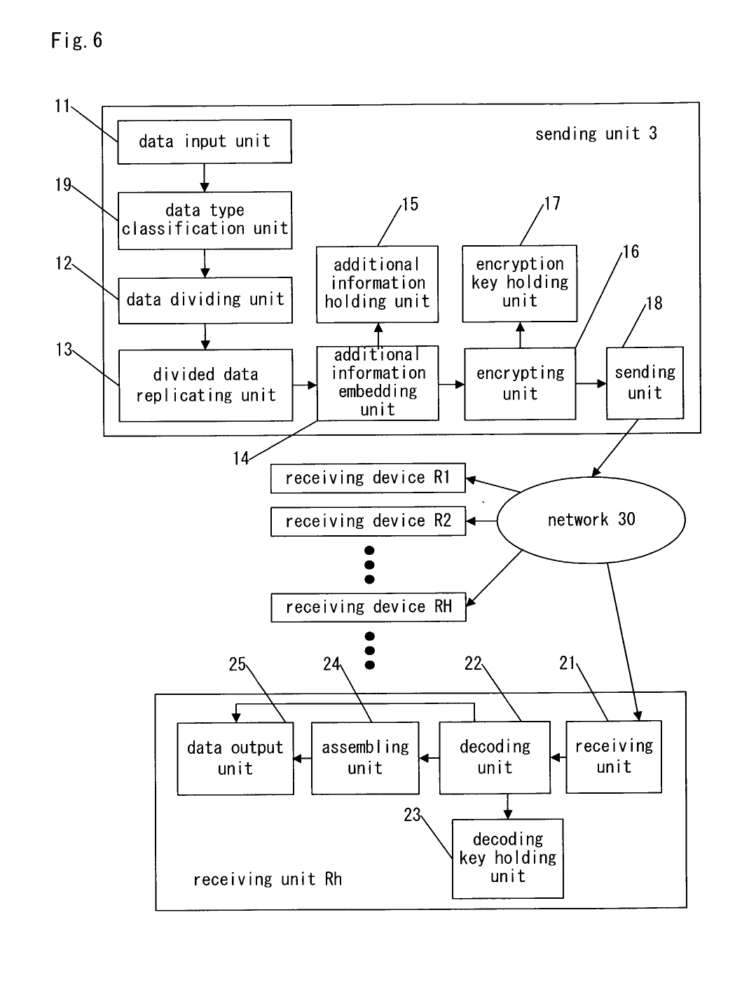

FIG. 6 is a block diagram of an exemplary data distribution system in Embodiment 1 of the present invention. Furthermore, in FIG. 6, the same parts as FIG. 1 or FIG. 4 are denoted by the same reference numerals, and an explanation thereof is omitted.

As shown in FIG. 6, this data distribution system has a sending device 3 and a plurality of receiving devices R1, R2, . . . , RH, . . . (collectively referred to as “Rh”). These devices are connected to the network 30.

The sending device 3 is composed of a data input unit 11, a data type classification unit 19, a data dividing unit 12, a divided data replicating unit 13, an additional information embedding unit 14, an additional information holding unit 15, an encrypting unit 16, an encryption key holding unit 17, and a sending unit 18.

The receiving device Rh is composed of a receiving unit 21, a decoding unit 22, a decoding key holding unit 23, an assembling unit 24 and a data output unit 25.

Next, the operation of each structure will be explained. First, the sending device 3 will be explained.

The data input unit 111 inputs the data to be sent. The data classification unit 19 classifies the input data for each type, the data of the type to be divided is output to the data dividing unit 12.

The data dividing unit 12 divides the data output by the data type classification unit 19 into a plurality of pieces so as to prepare divided data. Furthermore, the division of the data by the data dividing unit 12 means time division of the data. The divided data replicating unit 13 replicates a part or the entirety of the divided data prepared by the data dividing unit 12 and thereby prepares replicated data.

The additional information holding unit 15 holds the additional information to be embedded into the replicated data. The additional information embedding unit 14 embeds the additional information obtained from the additional information holding unit 15 into the replicated data prepared by the divided data replicating unit 13 so as to prepare additional information embedded data.

The encryption key holding unit 17 holds encryption keys required for the encryption of the data. The encryption unit 16 encrypts the additional information embedded data with the encryption keys obtained from the encryption key holding unit 17 and thereby prepares encrypted data.

The sending unit 18 distributes the encrypted data prepared by the encrypting unit 16 to a plurality of sending devices Rh by means of multicast communications or broadcast communications by using the network 30

Next, the receiving device Rh will be explained.

The receiving unit 21 receives the encrypted data distributed by the sending unit 18. The decoding key holding unit 23 holds decoding keys required for decoding the data.

The decoding unit 22 subjects the encrypted data received by the receiving unit 21 to the decoding processing by means of the decoding keys obtained from the decoding key holding unit 23 and thereby prepares decoded data.

The encrypted data which has not been decoded is not output to the assembling unit 24, and the decoding unit 22 discards the data.

The assembling unit 24 assembles the decoded data prepared by the decoding unit 22. The data output unit 25 outputs the data assembled by the assembling unit 24.

Furthermore, in the case where the receiving unit 21 receives the divided data which has not been encrypted and gives the unencrypted data to the decoding unit 22, the decoding unit 22 does not perform the decoding processing, and the unencrypted divided data is output to the assembling unit 24. The assembling unit 24 assembles the divided data.

Furthermore, in the case where the receiving unit 21 receives data which is neither divided nor encrypted and the data is given to the decoding unit 22, the decoding unit 22 outputs the data to the data output unit 25 without performing the decoding processing. Then, the data output unit 25 outputs the data.

Next, the data dividing unit 12 and the divided data replicating unit 13 will be explained in detail. The number of divisions by the data dividing unit 12 is set to 2 or more. The number of divisions may be any number as long as it is two or more.

The number of replications by the divided data replicating unit 13 with respect to a piece of divided data is set to 2 or more. The number of replications may be any number as long as it is two or more.

Here, the number of divisions by the data dividing unit 12 is set to “m” while the number of replications with respect to a piece of divided data by the divided data replicating unit 13 is set to “n”.

A case in which different pieces of additional information are embedded and encrypted with different encryption keys with respect to all pieces of the replicated data is considered.

In this case, when additional information and an encryption key with respect to a piece of replicated data is conveniently considered as one set, the number of combinations of the sets of the additional information and the encryption key becomes (m-th power of n) in all the replicated data.

Consequently, data embedded with different pieces of additional information and encrypted with different encryption keys can be distributed to (m-th power of n) receiving devices (users).

Furthermore, in this case, the bandwidth required for the data distribution can be limited to a range of n times or less as compared with the case in which the data given to the data dividing unit 12 by the data type classification unit 19, embedded with different pieces of additional information and encrypted with different encryption keys is distributed.

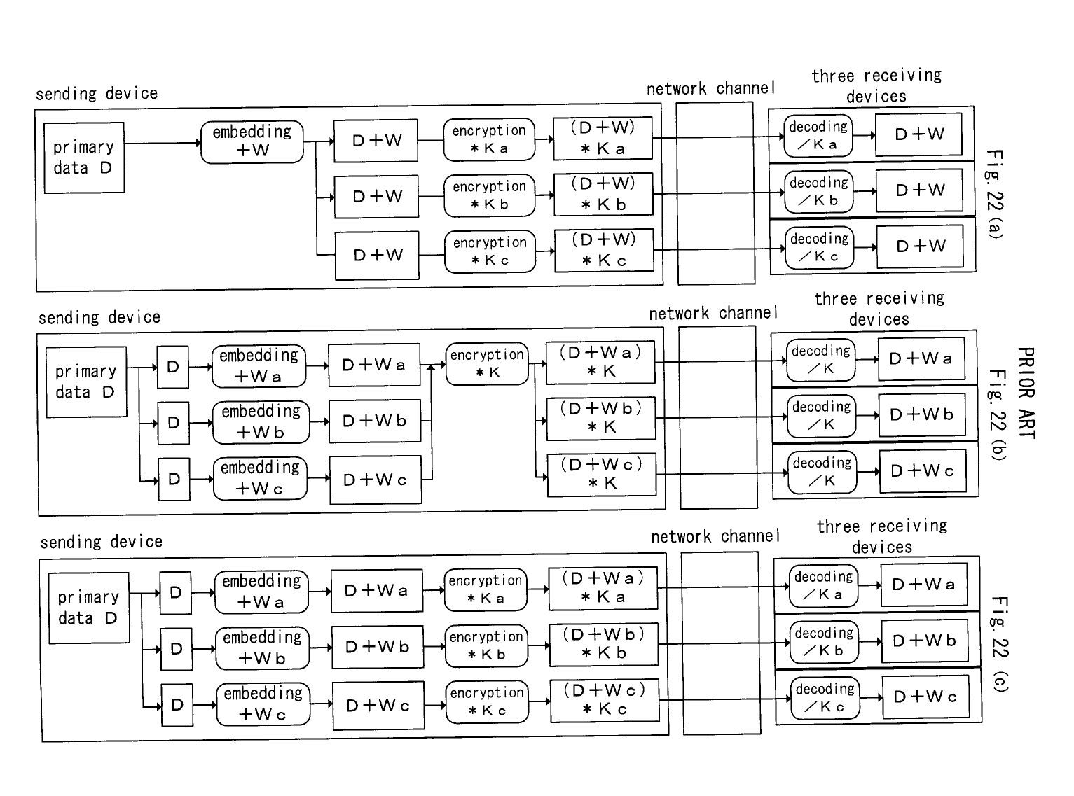

Furthermore, in this case, the bandwidth required for the data distribution will become ((1−m)th power of n) times as compared with the case (see FIG. 22(c)) in which the data embedded with different pieces of additional information and encrypted with different encryption keys is distributed to (m-th power of n) receiving devices (users) by means of unicast communications, and the bandwidth can be reduced.

Furthermore, in this case, the load of embedding processing of additional information and encryption processing becomes ((1−m)th power of n) times as compared with the case (see FIG. 22(c)) in which the data embedded with different pieces of additional information and encrypted with different encryption keys is distributed to (m-th power of n) receiving devices (users) by means of unicast communications, and the load can be reduced.

The above point will be explained by citing concrete examples.

Here, it is assumed that the number of divisions is m=3 and the number of replications is n=2. Then, a case in which all replicated data is embedded with different pieces of additional information and encrypted with different encryption keys is considered.

In this case, when a piece of additional information and an encryption key with respect to a piece of replicated data are considered as one set, the number of combinations of the sets of the additional information and the encryption key becomes the third power of two, namely, eight.

Consequently, the data embedded with different pieces of additional information and encrypted with different encryption keys can be distributed to eight receiving devices (eight users).

Furthermore, in this case, the bandwidth required for the data distribution can be limited to a range of two times or less as compared with the case in which the data given to the data dividing unit 12 by the data type classification unit 19, embedded with the different pieces of additional information and encrypted with different encryption keys is distributed.

Furthermore, in this case, the bandwidth required for the data distribution will become ((1−3)-th power of 2) times, namely, 1/4 times as compared with the case in which the data embedded with different pieces of additional information and encrypted with different encryption keys is distributed to eight receiving devices (eight users) by means of unicast communications, and the bandwidth can be reduced.

Furthermore, in this case, the load of embedding processing of additional information and encryption processing can be limited to a range of ((1−3)-th power of 2) times, namely, 1/4 times as compared with the case in which the data embedded with the different pieces of additional information and encrypted with different encryption keys is distributed to eight receiving devices (eight users) by means of unicast communications, whereby the bandwidth can be reduced.

Here, it is assumed that the number of divisions is m=8 and the number of replications is n=10. Then, a case in which all replicated data is embedded with different pieces of additional information and encrypted with different encryption keys is considered.

In this case, when a piece of additional information and an encryption key with respect to a piece of replicated data is considered as one set, the number of combinations of the sets of the additional information and the encryption key becomes (eighth power of 10), namely, 100000000 for all the replicated data.

Consequently, the data embedded with different pieces of additional information and encrypted with different encryption keys can be distributed to 100000000 receiving devices (100000000 users).

Furthermore, in this case, the bandwidth required for the data distribution can be limited to a range of 10 times or less as compared with the case in which the data given to the data dividing unit 12 by the data type classification unit 19, embedded with the different pieces of additional information and encrypted with different encryption keys is distributed

Furthermore, in this case, the bandwidth required for the data distribution can be limited to a range of ((1−8)th power of 10) times, namely, 1/10000000 times as compared with the case in which the data embedded with different pieces of additional information and encrypted with encryption keys is distributed by means of unicast communications to 100000000 receiving devices (100000000 users), whereby the bandwidth can be reduced.

Furthermore, in this case, the load of embedding processing of additional information and of encryption processing can be limited to a range of ((1−8)th power of 10) times, namely, 1/10000000 times as compared with the case in which the data embedded with different pieces of additional information and encrypted with different encryption keys is distributed to 100000000 receiving devices (100000000 users) by means of unicast communications, whereby the load can be reduced.

Furthermore, in the case where the divided data is prepared by the data dividing unit 12, the length of the divided data can be arbitrarily set. Furthermore, in the case where a piece of data is divided so as to prepare a plurality of divided data, the length of each piece of divided data can be made different.

Furthermore, embedding of the additional information by the additional information embedding unit 14 and encrypting by the encrypting unit 16 can be performed with respect to all the types of data, and not necessarily required to be performed for all the types of data.

For example, with respect to the audio video image data, the data is of three types; the video image data, the right side data and the left side data.

Consequently, in this case, with respect to all types of data, division by the data dividing unit 12, replication by the divided data replicating unit 13, embedding of additional information by the additional information embedding unit 14 and encrypting by the encrypting unit 16 may be performed.

Furthermore, with respect to one type or two types of data out of three types of data, dividing processing by the data dividing unit 12, replication processing by the divided data replicating unit 13, embedding of the additional information by the additional information embedding unit 14 and encryption processing by the encrypting unit 16 may be performed while these types of processing may not be performed with respect to the remaining types of data.

Furthermore, since dividing processing, replicating processing, additional information embedding processing, and encryption processing can be independently performed for each type of data, the number of divisions, the length of divided data and the number of replications are not required to be set to be the same for all types of data.

For example, in an example of the above-mentioned audio video image data, in the case where all three types of data are subjected to dividing processing, replication processing and additional information embedding processing, and encryption processing, the number of divisions, the length of the divided data and the number of replications are not required to be set to be the same for the video image data, the right side audio data and the left side audio data.

Next, the flow of processing in the sending device 3 in the present embodiment will be explained by use of a flowchart.

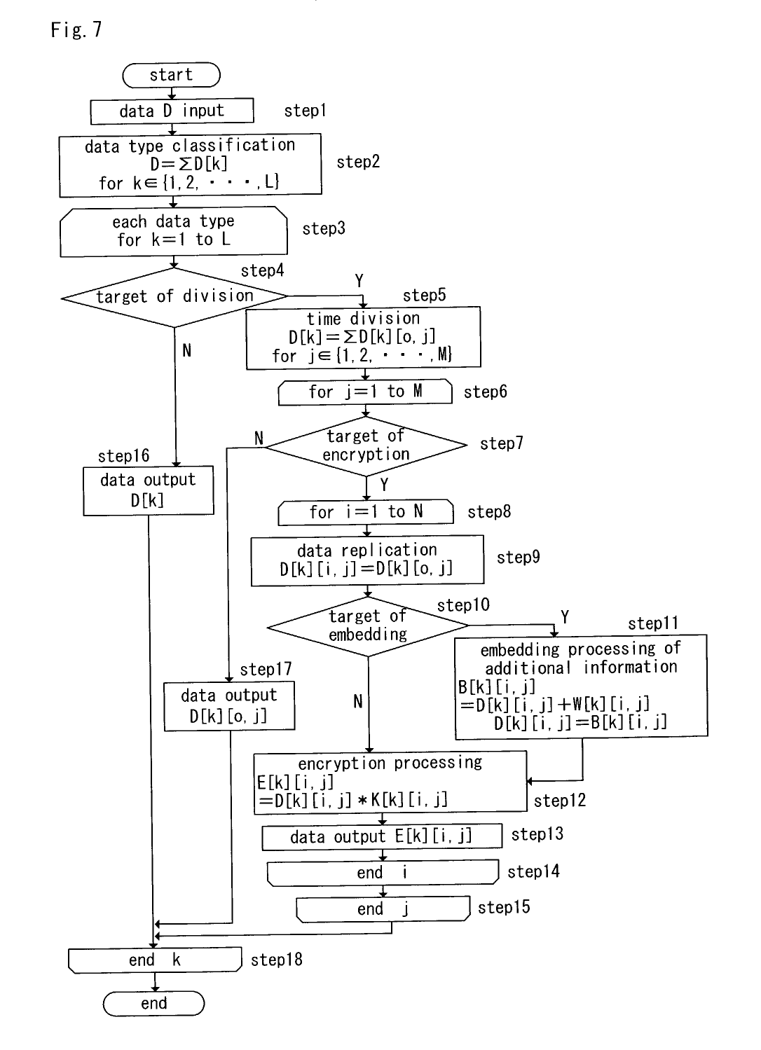

FIG. 7 is a flowchart of the exemplary sending device 3 in the present embodiment. As shown in FIG. 7, at step 1, the data input unit 11 inputs data D.

Next, at step 2, the data type classification unit 19 classifies the input data D for each type. “k” in FIG. 7 denotes a number for identifying the type of data (data type number). Furthermore, for example, in the case where the input data D is the audio video image data, the input data is composed of three types of data; the video image data, the right side audio data, and the left side audio data. Thus, in FIG. 7, L=3 is given.

An explanation is given by citing as an example a case in which the audio video image data D is input. Then, a target of division by the data division dividing unit 12 is set as the left side audio data inside three types of data constituting the audio video image data.

Furthermore, the processing from step 4 through step 17 are performed for each type of data (step 3 and step 18).

At step 4, the data type classification unit 19 judges as to whether the type of data is the target of division. Then, when the type of data is the target of division, the data is output to the data dividing unit 12 to proceed to step 5.

In the above-mentioned example, in the case where the type of data is the left side audio data, the data type classification unit 19 outputs the left side audio data D[k] to the data dividing unit 12.

Next, at step 5, the data dividing unit 12 divides the left side audio data D[k] so as to prepare a plurality of divided data D[k] [0, j]. Here, “j” in FIG. 7 is a numeral (time division number) for identifying the divided data. Furthermore, for example, in the case where the number of divisions is set to three, M=3 is given in FIG. 7. Furthermore, numeral “0” in the divided data D[k] [0, j] shows that the number of replications at this point is “0”.

Next, the processing from step 7 to step 14 is repeated from j=1 up to j=M (step 6 and step 15).

At step 7, the data dividing unit 12 judges as to whether the divided data D[k] [0, j] is a target of encryption or not.

Then, in the case where the data dividing unit 12 judges that the divided data D[k] [0, j] is not the target of encryption, the data dividing unit outputs the divided data D[k] [0, j] to the sending unit 18.

On the other hand, in the case where the data dividing unit 12 judges that the divided data D[k] [0, j] is a target of encryption, the data dividing unit 12 outputs the divided data D[k] [0, j] to the divided data replicating unit 13 to proceed to step 8.

Next, the processing of step 9 through step 13 is repeated from i=1 up to i=N (step 8 and step 14). “i” is a number (replication number) for identifying the replicated data. For example, where the number of replications is two, N=2 is given.

At step 9, the divided data replicating unit 13 replicates the divided data D[k] [0, j] so as to prepare the replicated data D[k] [I, j].

Next, at step 10, the divided data replicating unit 13 judges as to whether the replicated data D[k] [i, j] is a target of embedding processing of the additional information.

Then, in the case where the divided data replicating unit 13 judges that the replicated data D[k] [I, j] is not the target of embedding processing of additional information, the divided data replicating unit 13 outputs the replicated data D[k] [i, j] to the encrypting unit 16 to proceed to step 12.

On the other hand, in the case where the divided data replicating unit 13 judges that the replicated data D [k][I, j] is the target of embedding processing of additional information, the divided data replicating unit 13 outputs the replicated data D[k] [I, j] to the additional information processing unit 14 to proceed to step 11.

Next, at step 11, the additional information replicating unit 14 embeds the additional information W[k] [i, j] into the replicated data D[k] [i, j] so as to prepare the additional information embedded data B[k] [i, j]. Subsequently, the additional information embedding unit 14 sets D[k] [i, j]=B[k] [i, j]. Furthermore, “+” in the figures denotes that the additional information is embedded.

Furthermore, at step 12, the encrypting unit 16 encrypts with the encryption key K[k] [i, j] the replicated data D[k] [i, j] (in the case where the data is not the target of embedding processing of the additional information) output by the divided data replicating unit 13, and the additional information embedded data D[k] [i, j] (in the case where the data is the target of embedding processing of the additional information) output by the additional information embedding unit 14 and thereby prepares the encrypted data E[k] [i, j]. Furthermore, “*” in the figures denotes that the data is encrypted.

Next, in step 13, the encrypting unit 16 outputs the encrypted data E [E][i, j] to the sending unit 18.

Furthermore, when the data type classification unit 19 judges that the type of data is not the target of division at step 4, the data type classification unit 19 outputs, at step 16, the data D[k] to the sending unit 18.

In the above-mentioned example, in the case where the type of data is the video image data or the right side audio data, the data type classification unit 19 outputs these pieces of data D[k] to the sending unit 18.

Furthermore, the flow of processing in the receiving device Rh in the present embodiment is the same as the flow of processing in the receiving device Rh in Embodiment 1. That is, the flow of processing in the receiving devices Rh in the present embodiment is the same as the flow of processing shown in the flowchart of FIG. 3.

Next, the processing of the data distribution system in the present embodiment will be explained by citing a concrete example.

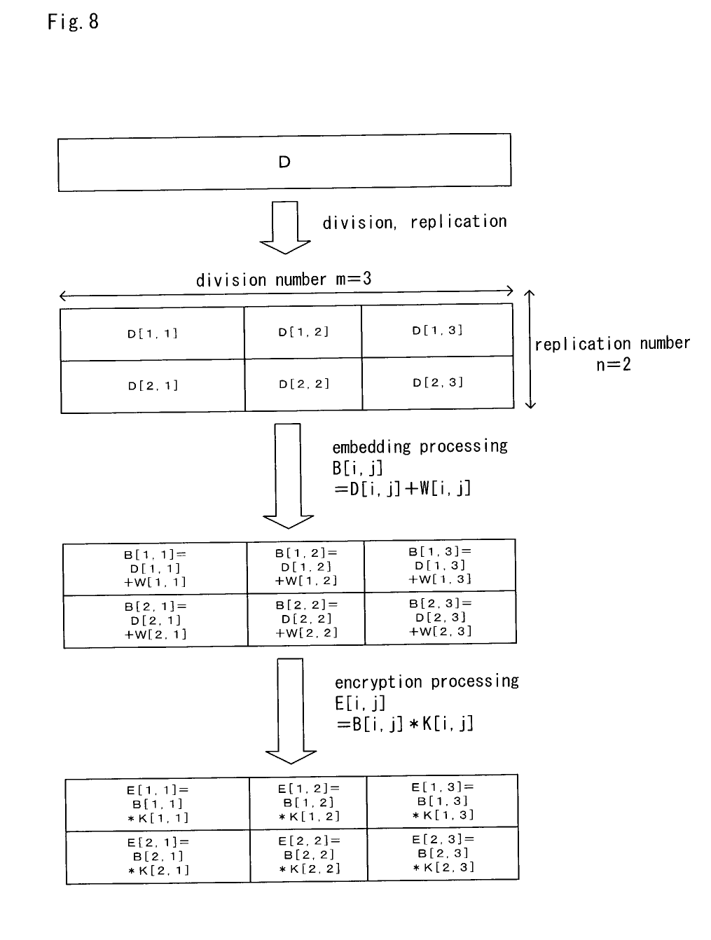

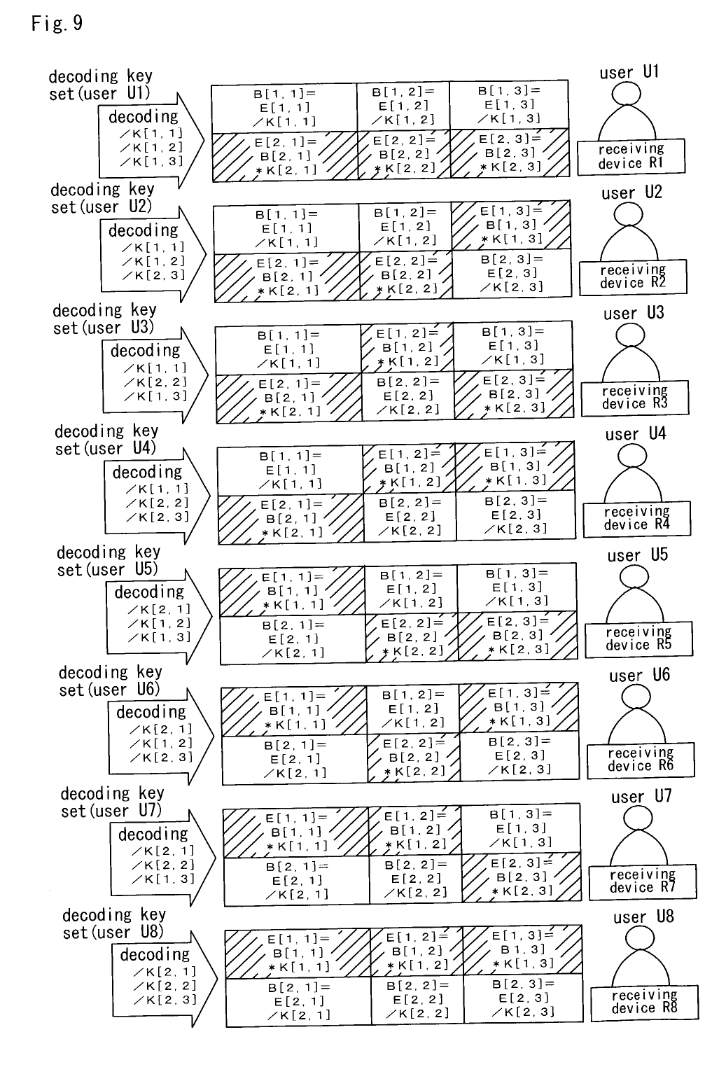

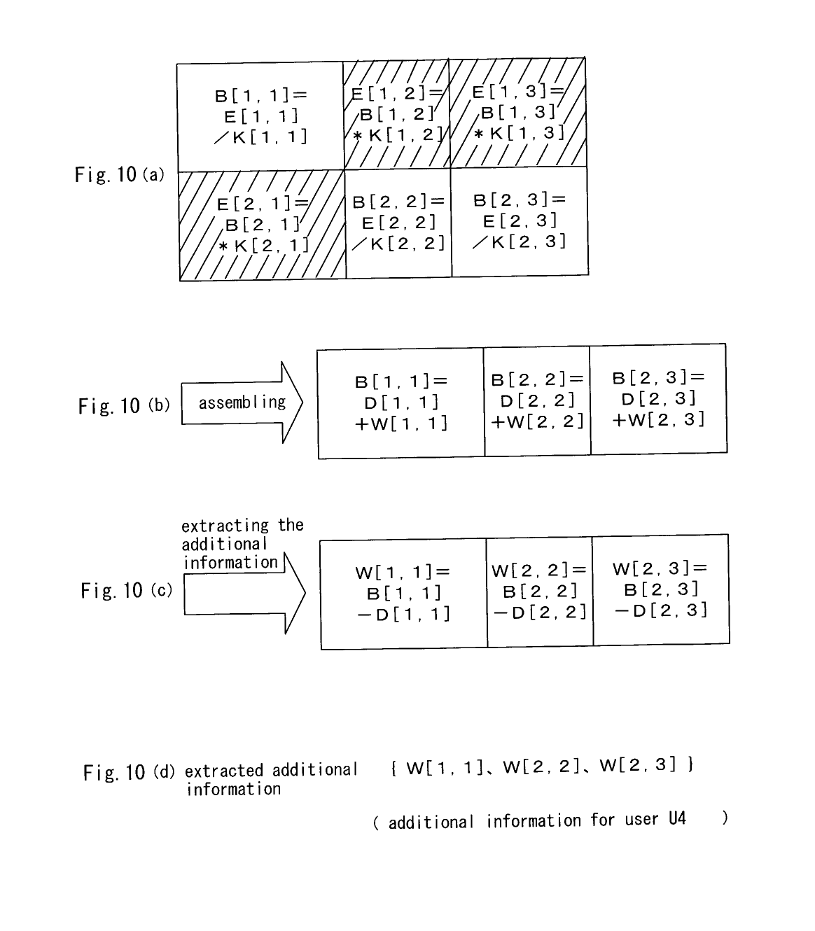

FIG. 8 is a view for illustrating the processing by the exemplary sending device 3 in the present embodiment. FIG. 9 is a view for illustrating the processing of decoding the data by the exemplary decoding unit 22 in the exemplary receiving devices Rh in the present embodiment. FIG. 10 is a view for illustrating the processing of assembling data by the exemplary assembling unit 24 of the exemplary receiving devices Rh in the present embodiment.

In an example of FIG. 8 through FIG. 10, the number m of divisions by the data dividing unit 12 is set to “3” while the number of replications n by the divided data replicating unit 13 is set to “2”.

Furthermore, out of the data D[k] classified by the data type classifying unit 19, the target of the division is set as the data D[1].

Furthermore, the manner of describing the data is the same as in FIG. 7 and FIG. 3. However, in the undermentioned description, for the sake of explanation, the data D[1] which becomes the target of division is described as “D” whereas “[1]” is omitted.

Furthermore, the data dividing unit 12 divides the input data D into three pieces of data to prepare the divided data D[0, 1], D[0, 2] and D[0, 3].

Then, as shown in FIG. 8, the divided data replicating unit 13 replicates the divided data D[0, 1], D[0, 2], and D[0, 3] so as to prepare the replicated data D[1, 1], D[2, 1], D[1, 2], D[2, 2], D[1, 3], and D[2, 3].

The additional information embedding unit 14 embeds different pieces of additional information W[1, 1] through W[2, 3] into this replicated data D [1, 1] through D[2, 3] so as to prepare the additional information embedded data B[1, 1] through B[2, 3].

The encrypting unit 16 subjects these additional information embedded data B[1, 1] through B[2, 3] to encryption processing with encryption keys K[1, 1] through K[2, 3] which are different from each other so as to prepare encrypted data E[1, 1] through E[2, 3].

The sending unit 18 distributes these encrypted data E[1, 1] through E[2, 3] to the receiving devices R1 through R8 of users U1 through U8 by means of multicast communications or broadcast communications (see FIG. 9).

Then, as shown in FIG. 9, in the receiving devices R1 through R8 of the users U1 through U8, the decoding unit 22 decodes the encrypted data E[1, 1] through E[2, 3] which are received by using the decoding keys held by the decoding key holding unit 23. Specifically, the process is as follows.

Each of the decoding key holding units 23 of each of the receiving devices R1 through R8 holds a set of decoding keys comprised of three decoding keys.

A combination of three decoding keys held by the decoding key holding units 23 is completely different from each of the decoding key holding units 23. That is, the decoding key sets held by each of the decoding key holding units 23 are completely different.

Consequently, in each of the receiving devices R1 through R8, only the encrypted data which is encrypted with the encryption key corresponding to the decoding key held by respective decoding key holding units 23 can be decoded.

For example, in the receiving device R1 of the user U1, the decoding key sets held by the receiving device R1 are “K[1, 1], K[1, 2] and K[1, 3]”, so that the encrypted data composed of a combination of “E[1, 1], E[2, 3] and E[2, 3] cannot be decoded.

Since six pieces encrypted data E[1, 1] through E[2, 3] are encrypted with completely different encryption keys K[1, 1] through K[2, 3], a combination of encrypted data which can be decoded by each of the receiving devices R1 through R8 is completely different.

Consequently, since completely different pieces of additional information W[1, 1] through W[2, 3] are embedded into six encrypted data E[1, 1] through E[2, 3], a combination of three pieces of additional information embedded is completely different in three decoded data prepared by each of the receiving devices R1 through R8.

Furthermore, in FIG. 9, the encrypted data denoted by slanted lines show the encrypted data (encrypted data which cannot be decoded) for which each of the receiving devices R1 through R8 (each of the users U1 through U8) do not hold the decoding key.

For example, in the receiving device R1 of the user U1, since the decoding key sets held by the receiving device R1 are “K[1, 1], K[1, 2] and K[1, 3]”, a combination of encrypted data “E[2, 2], E[2, 1] and E[2, 3] cannot be decoded.

Next, by using FIG. 10, data assembling processing by the data assembling unit 24 of the receiving devices R1 through R8 is explained. However, an explanation is given by observing the assembling unit 24 of the receiving device R4 of the user 4.

FIG. 10 is an explanatory view of the assembling processing of decoded data by the exemplary assembling unit 24. As shown in FIG. 10(a), since the decoding key sets held by the receiving device R4 are “K[1, 1], K[2, 2] and K[2, 3], encrypted data composed of a combination of “E[1, 1], E[2, 2] and E[2, 3]” is decoded.

Then, the decoded data composed of a combination of “B[1, 1], B[2, 2] and B[2, 3] can be obtained.

As shown in FIG. 10(b), the assembling unit 24 of the receiving device R4 assembles the decoded data composed of a combination of “B[1, 1], B[2, 2] and B[2, 3]” to obtain assembled data B[1, 1]B[2, 2]B[2, 3].

In this assembled data B[1, 1], B[2, 2], B[2, 3], the additional information W[1, 1], W[2, 2] and W[2, 3] are embedded.

In the assembled data obtained in each of the receiving devices R1 through R8, combinations of three pieces of additional information which are embedded are completely different. Consequently, it becomes possible to identify the secondary distribution source.

As shown in FIG. 10(c), in the case where the secondary distribution source is identified, the additional information embedded in the assembled data B[1, 1]B[2, 2] B[2, 3] is extracted. Furthermore, “−” means that the additional information is extracted.

Then, as shown in FIG. 10(d), additional information composed of a combination of “W[1, 1], W[2, 2] and W[2, 3] is extracted.

The assembled data to which the additional information composed of a combination of “W[1, 1], W[2, 2] and W[2, 3] is embedded is only assembled data B[1, 1]B[2, 2]B[2, 3] assembled by the receiving device R4 out of the assembled data assembled by the receiving devices R1 through R8.

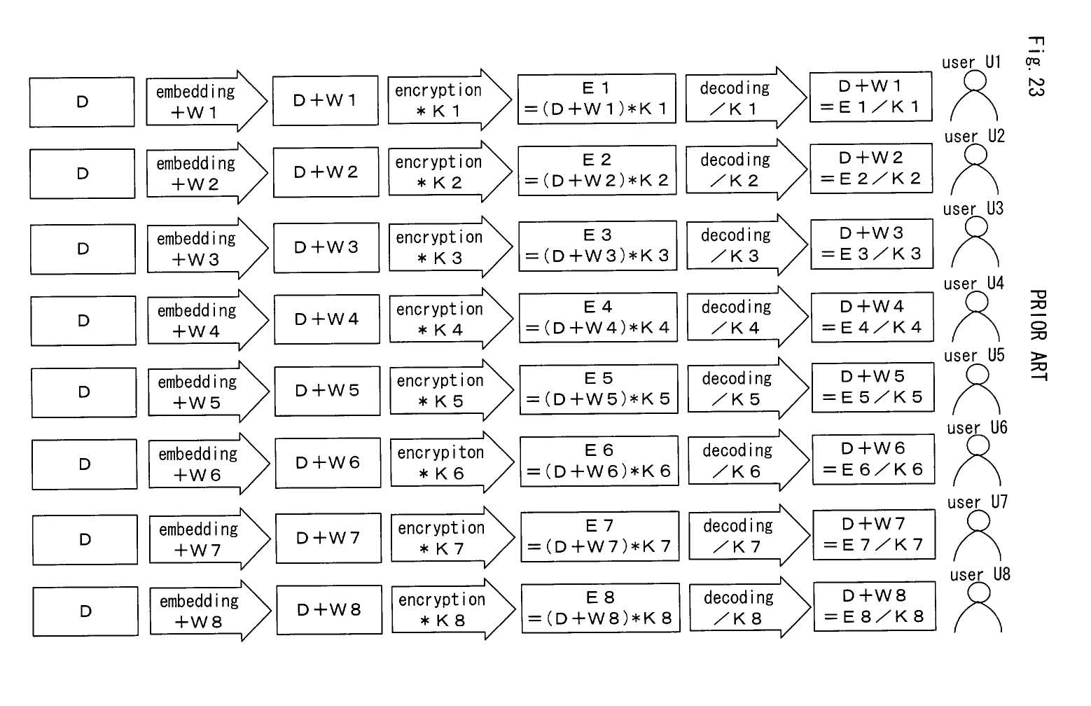

When examples of FIG. 8 and FIG. 9 according to the present embodiment are compared with the case in FIG. 23 according to the conventional embodiment, in the present embodiment, the data embedded with different pieces of additional information and encrypted with different encryption keys can be distributed to eight receiving devices (eight users) at 1/4 times the conventional bandwidth.

Furthermore, in the same manner as encrypting in the encrypting unit 16 in Embodiment 1 and the embedding processing of the additional information by the additional information embedding unit 14 in Embodiment 2, the replicated data and the original divided data can be used as the target of encrypting in the encrypting unit 16 and the embedding processing of additional information by the additional information embedding unit 14.

Furthermore, as described above, in this embodiment, the data input from the data input unit 11 of the sending device 3 is subjected to dividing processing by the data dividing unit 12 and replication processing by the divided data replicating unit 13. Subsequently, the data is subjected to embedding processing of additional information by the additional information embedding unit 14 and encryption processing by the encrypting unit 16 and distributed by means of multicast communications or by means of broadcast communications by the sending unit 18.

As a consequence, embedding processing of different pieces of additional information and encryption processing with different decoding keys with respect to the same data for each receiving device to which the data is distributed can be performed while suppressing the load of embedding processing of the additional information and encryption processing and an increase in the bandwidth required for data distribution.

That is, like the case in which the same data is embedded with different pieces of additional information, encrypted with different encryption keys and respectively distributed to the receiving devices, the load of embedding processing of the additional information and encryption processing does not increase and the bandwidth required for data distribution does not increase in proportion to the number of receiving devices to which the data is distributed.

Furthermore, in the case where the electronic watermark information is considered as an example of the additional information, since the same data is embedded with different pieces of additional information, encrypted with different encryption keys and respectively distributed to the receiving devices, the data embedded with electronic watermark information and the user thereof stand in a one-to-one relationship and data leakage and wiretapping can be prevented on the sending channel. Consequently, a target of the electronic watermark information for identifying the secondary distribution source can be effectively attained.

Furthermore, the data type classification unit 19 classifies the data composed of a plurality of types of input data for each type, and outputs the data of the type which is predetermined as the target of division to the data dividing unit 12.

Thus, it becomes possible to subject the data of the type which is arbitrarily selected out of data composed of the plurality of types to the embedding processing of additional information, and encryption processing.

As a consequence, it becomes possible to take a flexible response even in the case where all types of data are not necessarily subjected to embedding processing of additional information and encryption processing.

Furthermore, when only the specific type of data out of the plurality of types of data is subjected to embedding processing of additional information and encryption processing, an increase in the load of embedding processing of the additional information and encryption processing can be further suppressed and an increase in the bandwidth required for data distribution can be further suppressed.

For example, with respect to the audio video image data, it is considered that only one type or two types of data can be subjected to embedding of the additional information and encrypting out of the video image data, the right side audio data, and the left side audio data.

Next, processing in a case in which the sending unit 18 of the sending device 3 in FIG. 6 distributes the encrypted data prepared by the encrypting unit 16 to a plurality of receiving devices Rh by means of multicast communications will be explained by giving concrete examples.

In the undermentioned explanation, a case in which the data is distributed to nine receiving devices R1 through R9 out of a plurality of receiving devices Rh is given as an example.

Hereinbelow, an example of the processing in which multicast communications is performed will be explained by use of drawings.

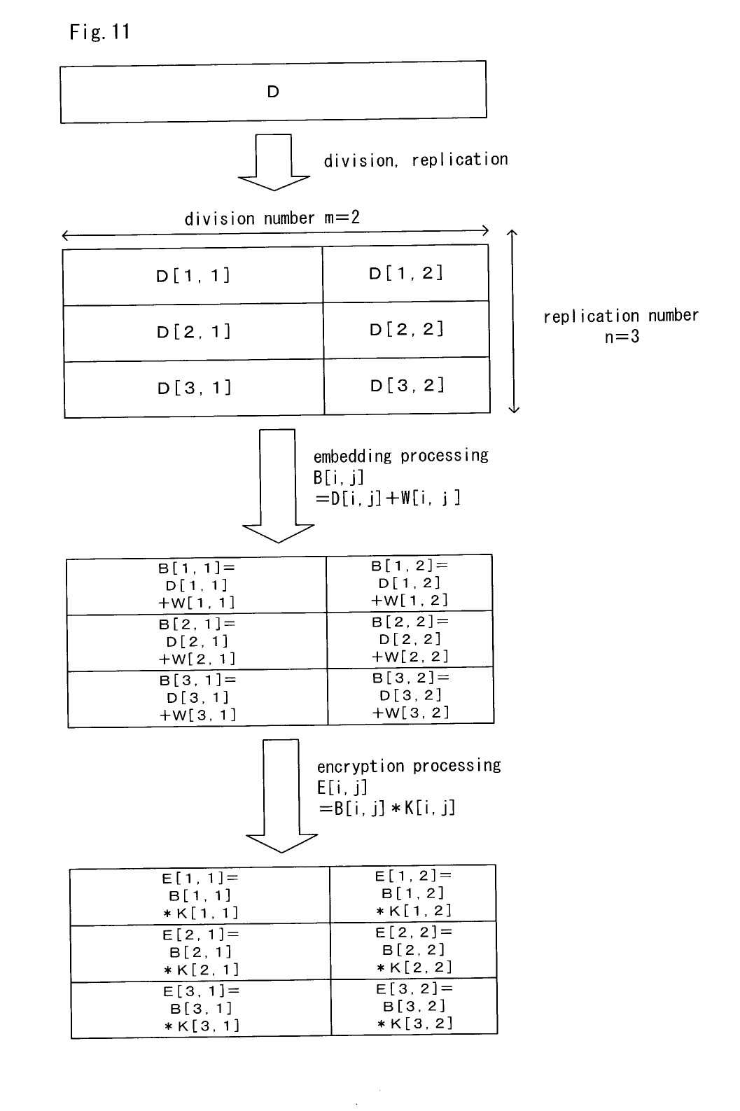

FIG. 11 is an explanatory view of processing by the exemplary sending device 3 in FIG. 6 in the case in which multicast communications are performed.

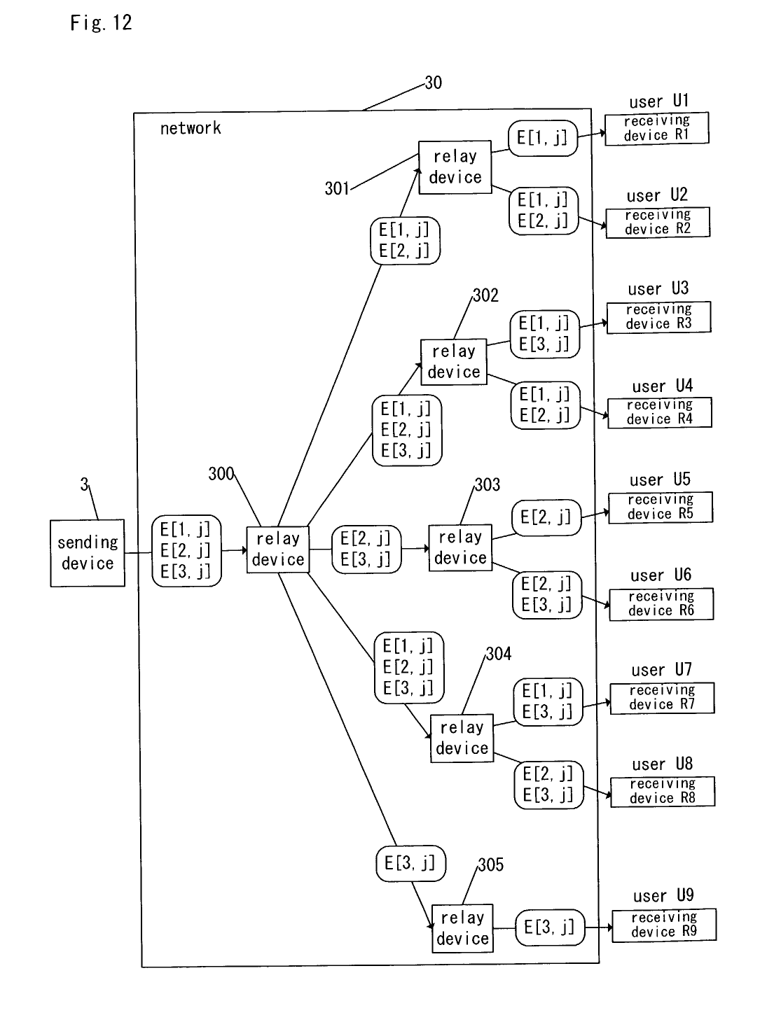

FIG. 12 is an explanatory view of an exemplary data sending channel in the case in which multicast communications are performed. Furthermore, in FIG. 12, the same parts as FIG. 6 are denoted by the same numerals.

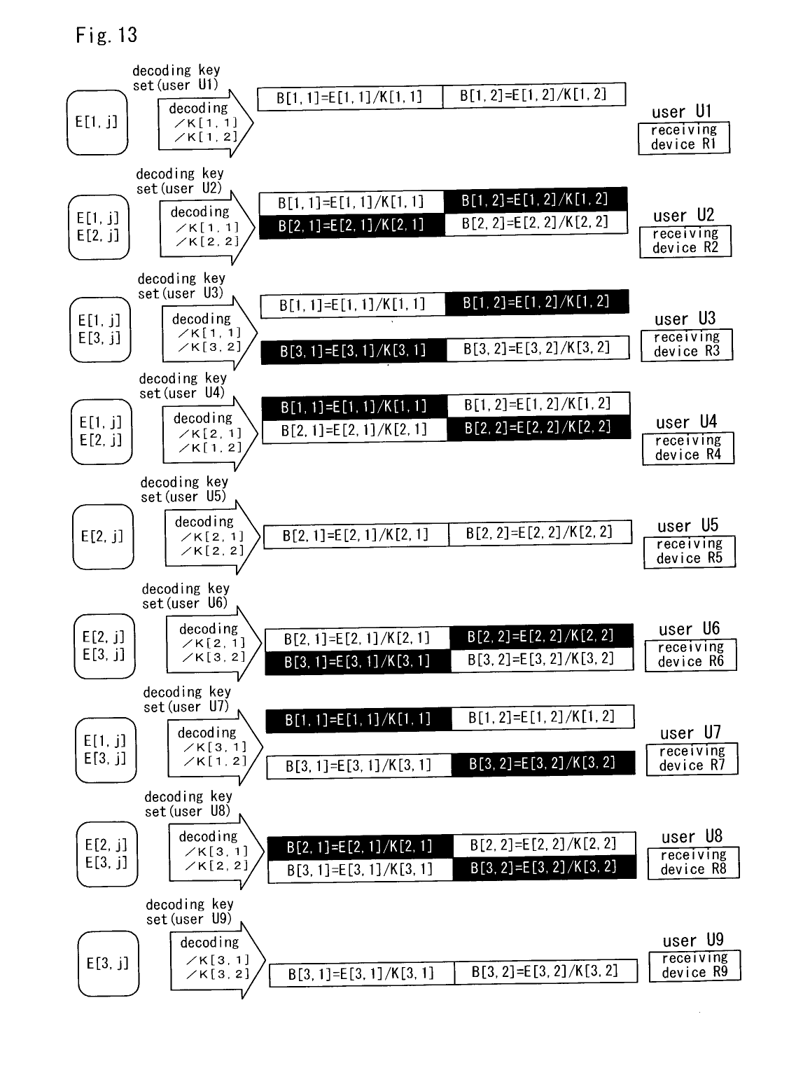

FIG. 13 is an explanatory view of the processing by receiving devices R1 through R9 in FIG. 6 in the case where multicast communications are performed.

Furthermore, as the network 30 in FIG. 12, for example, the Internet can be given.

Furthermore, as the relay devices 300 through 305 of FIG. 12, for example, a router can be given.

Furthermore, in the example in FIG. 11, the number m of divisions by the data dividing unit 12 is set to “2” while the number of replications n by the divided data replicating unit 13 is set to “3”.

Furthermore, out of the data D[k] classified by the data type classification unit 19, the target of division is the data D[1].

Furthermore, the method for describing the data is the same as in FIG. 7 and FIG. 3. However, in the undermentioned description, for the sake of explanation, the data D[l] which is the target of division is described as “D”, and “[1]” is omitted.

Furthermore, the data dividing unit 12 divides the input data D into two pieces of data so as to prepare the divided data D[0, 1]. D[0, 2].

Then, as shown in FIG. 11, the divided data replicating unit 13 replicates the divided data D[0, 1], D[0, 2] so as to prepare the replicated data D[1, 1], D[2, 1], D[3, 1], D[1, 2], D[2, 2], and D[3, 2].

The additional information embedding unit 14 embeds different pieces of additional information W[1, 1] through W[3, 2] respectively into these pieces of replicated data D[1, 1] through D[3, 2] so as to prepare the additional information embedded data B[1, 1] through B[3, 2].

The encrypting unit 16 subjects these additional information embedded data B[1, 1] through B[3, 2] to encryption processing with encryption keys K[1, 1] through k[3, 2] which are different from each other so as to prepare the encrypted data E[1, 1] through E[3, 2].

The sending unit 18 distributes these encrypted data E[1, 1] through E[3, 2] to the receiving devices R1 through R9 of the users U1 through U9 via the network 30 by means of multicast communications (see FIG. 12).

In this case, the encrypted data E[1, j] is sent to the receiving device Rh in which the multicast address α is set.

The encrypted data E[2, j] is sent to the receiving device Rh in which the multicast address β is set.

The encrypted data E[3, j] is sent to the receiving device Rh in which the multicast address γ is set.

Here, since the decoding key sets held by the receiving device R1 are K[1, 1] and K[1, 2], it is considered that the multicast address α is set in this receiving device R1.

Since the decoding key sets held by the receiving device R2 are “K[1, 1] and K[2, 2], multicast addresses α and β are set in the receiving device R2.

Since the decoding key sets held by the receiving device R3 are “K[1, 1] and K[3, 2], multicast addresses α and γ are set in the receiving device R3.

Since the decoding key sets held by the receiving device R4 are “K[2, 1] and K[1, 2], multicast addresses α and β are set in the receiving device R4.

Since the decoding key sets held by the receiving device R5 are “K[2, 1] and K[2 2], multicast address β is set in the receiving device R5.

Since the decoding key sets held by the receiving device R6 are “K[2, 1] and K[3, 2], multicast addresses β and γ are set in the receiving device R6.

Since the decoding key sets held by the receiving device R7 are “K[3, 1] and K[1, 2], multicast addresses α and γ are set in the receiving device R7.

Since the decoding key sets held by the receiving device R8 are “K[3, 1] and K[2, 2], multicast addresses β and γ are set in the receiving device R8.

Since the decoding key sets held by the receiving device R9 are “K[3, 1] and K[3, 2], multicast address γ is set in the receiving device R9.

As has been described above, since multicast addresses are set, the encrypted data E[1, j] is sent respectively to the receiving devices R1, R2, R3, R4 and R7 as shown in FIG. 12.

The encrypted data E[2, j] is sent respectively to the receiving devices R2, R4, R5, R6 and R8.

The encrypted data E[3, j] is sent respectively to the receiving devices R3, R6, R7, R8 and R9.

In greater detail, the three pieces of encrypted data E[1, j], E[2, j] and E[3, j] are distributed to the receiving devices Rh in the following manner.

As shown in FIG. 12, the sending unit 18 of the sending device 3 sends the encrypted data E[1, j], E[2, j] and E[3, j] to the relaying device 300.

The relaying device 300 transmits the encrypted data E[1, j] and E[2, j] to the relaying device 301.

The relaying device 301 transmits the encrypted data E[1, j] to the receiving device R1. The relaying device 301 transmits the encrypted data E[1, j] and E[2, j] to the receiving device R2.

The relaying device 300 transmits the encrypted data E[1, j], E[2, j] and E[3, j] to the relaying device 302.

The relaying device 302 transmits the encrypted data E[1, j]and E[3, j] to the receiving device R3. The relaying device 302 transmits the encrypted data E[1, j] and E[2, j] to the receiving device R4.

The relaying device 300 transmits the encrypted data E[2, j], E[3, j] to the relaying device 303.

The relaying device 303 transmits the encrypted data E[2, j] to the receiving device R5. The relaying device 303 transmits the encrypted data E[2, j] and E[3, j] to the receiving device R6.

The relaying device 300 transmits the encrypted data E[1, j], E[2, j] and E[3, j] to the relaying device 304.

The relaying device 304 transmits the encrypted data E[L, j] and E[3, j] to the receiving device R7. The relaying device 304 transmits the encrypted data E[2, j] and E[3, j] to the receiving device R8.

The relaying device 300 transmits the encrypted data E[3, j] to the relaying device 305.

The relaying device 305 transmits the encrypted data E[3, j] to the receiving device R9.

Furthermore, as shown in FIG. 13, the receiving device R1 in which the multicast address α is set receives the encrypted data E[1, j].

Then, the decoding unit 22 of the receiving device R1 decodes the encrypted data E[1, j] which has been received by using the decoding keys K[1, 1] and K[1, 2].

Then, the decoding unit 22 of the receiving device R1 obtains the decoded data B[1, 1] and B[1, 2].

These decoded data B[1, 1] and B[1, 2] are assembled by the assembling unit 24 of the receiving device R1.

Furthermore, the receiving device R2 in which multicast addresses α and β are set receives the encrypted data E[1, j] and E[2, j].

Then, the decoding unit 22 of the receiving device R2 decodes the encrypted data E[1, j] and E[2, j] which has been received by using the decoding keys K[1, 1] and K[2, 2].

Then, the decoding unit 22 of the receiving device R2 obtains the decoded data B[1, 1] and B[2, 2].

These decoded data B[1, 1] and B[1, 2] are assembled by the assembling unit 24 of the receiving device R2.

Furthermore, since the receiving device R2 does not hold the decoding keys K[2, 1] and K[1, 2], the encrypted data E[2, 1] and E[1, 2] cannot be decoded.

In FIG. 13, the encrypted data which is shaded black show the encrypted data for which the receiving device Rh does not hold the decoding keys.

Hereinafter, in the same manner, the receiving devices R3 through R9 decode the encrypted data E[1, j], E[2, j] and E[3, j] by using the decoding keys held and assemble the data.

Furthermore, in Embodiment 1 or Embodiment 2 as well, in the same manner as FIG. 11 through FIG. 13, the data can be distributed by means of multicast communications.

Furthermore, a processing in the case in which the sending unit 18 of the sending device 3 in FIG. 6 distributes the encrypted data prepared by the encrypting unit 16 to a plurality of receiving devices Rh by means of broadcast communications will be explained by citing examples.

Hereinafter, an example of the processing in the case where broadcast communications are performed will be explained by use of the drawings.

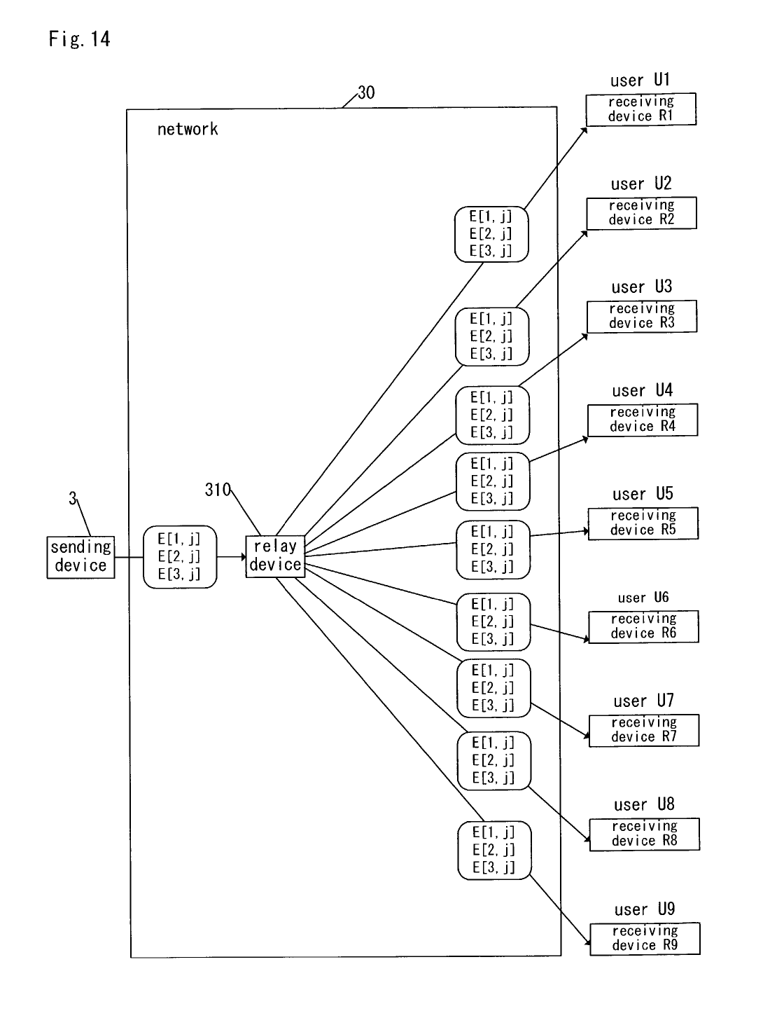

FIG. 14 is an explanatory view of an exemplary data sending channel in the case where broadcast communications are performed. Furthermore, in FIG. 14, the same parts in FIG. 6 are denoted by the same reference numerals.

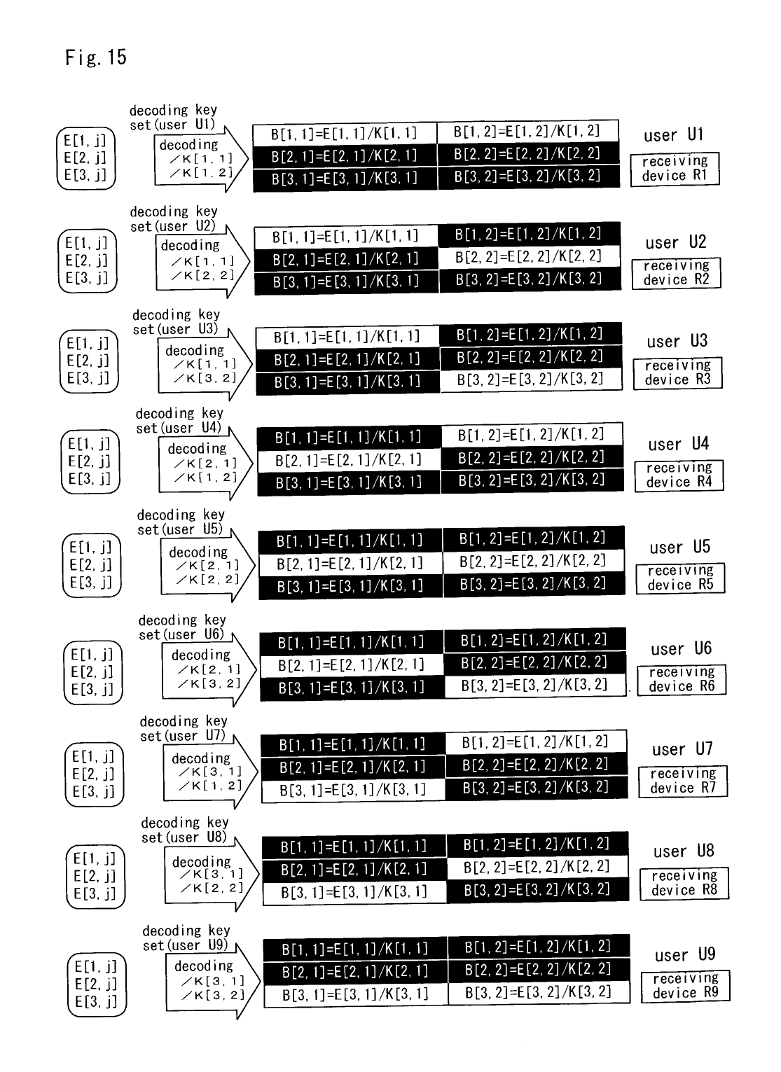

FIG. 15 is an explanatory view of the processing by the receiving devices R1 through R9 in FIG. 9 in the case where broadcast communications are performed.

Furthermore, as the network 30 in FIG. 14, for example, a broadcasting network can be given.

Furthermore, as the relaying device 310 in FIG. 14, for example, the relaying device of the wireless relay station in the ground-based television broadcasting network, the head-end of the CATV (cable television) or the like can be cited.

Furthermore, as the relaying device 310, for example, a broadcasting satellite in the satellite-type television broadcasting, a communications satellite or the like can be given.

Furthermore, preparation processing of the encrypted data E[1, j], E[2, j] and E[3, j] are the same as processing shown in FIG. 11, and an explanation thereof is omitted.

Furthermore, as shown in FIG. 14, the sending unit 18 of the sending device 3 distributes the encrypted data E[1, j], E[2, j] and E[3, j] which have been prepared to the sending devices R1 through R9 of the users U1 through U9 via the network 30 by means of broadcast communications.

Consequently, all the encrypted data E[1, j], E[2, j] and E[3, j] is distributed to all the receiving devices R1 through R9.

With respect to this point, broadcast communications are significantly different from multicast communications in which the encrypted data is distributed to the receiving device Rh for which corresponding multicast addresses are set.

In greater detail, in the following manner, the encrypted data E[1, j], E[2, j] and E[3, j] are distributed to the receiving device Rh.

As shown in FIG. 14, the sending unit 18 of the sending device 3 distributes the encrypted data E[1, j] and E[2, j] and E[3, j] to the relaying device 310.

The relaying device 310 distributes all the encrypted data E[1, j], E[2, j] and E[3, j] to all the receiving devices R1 through R9.

Furthermore, as shown in FIG. 15, the receiving device R1 receives all the encrypted data E[1, j], E[2, j] and E[3, j].

Then, the decoding unit 22 of the receiving device R1 subjects the encrypted data E[1, j], E[2, j] and E[3, j] which have been received to decoding processing by using the decoding keys K[1, 1] and K[1, 2].

Then, the decoding unit 22 of the receiving device R1 obtains the decoded data B[1, 1] and B[1, 2].

These decoded data B[1, j] and B[1, 2] are assembled by the assembling unit 24 of the receiving device R1.

Furthermore, since the receiving device R1 does not hold the decoding keys K[2, 1], R[2, 2], R[3, 1] and R[3, 2], the receiving device R1 cannot decode the encrypted data E[2, 1], E[2, 2], E[3, 1] and E[3, 2].

In FIG. 15, the encrypted data which is shaded black shows the encrypted data for which the receiving device Rh does not hold the decoding keys.

Hereinafter, in the same manner, the receiving devices R2 through R9 which have received all the encrypted data E[1, j], E[2, j] and E[3, j] perform decoding by using the held decoding keys.

Furthermore, in Embodiment 1 or Embodiment 2 as well, in the same manner as FIG. 11, FIG. 14 and FIG. 15, the data can be distributed by means of broadcast communications.

(Embodiment 4)

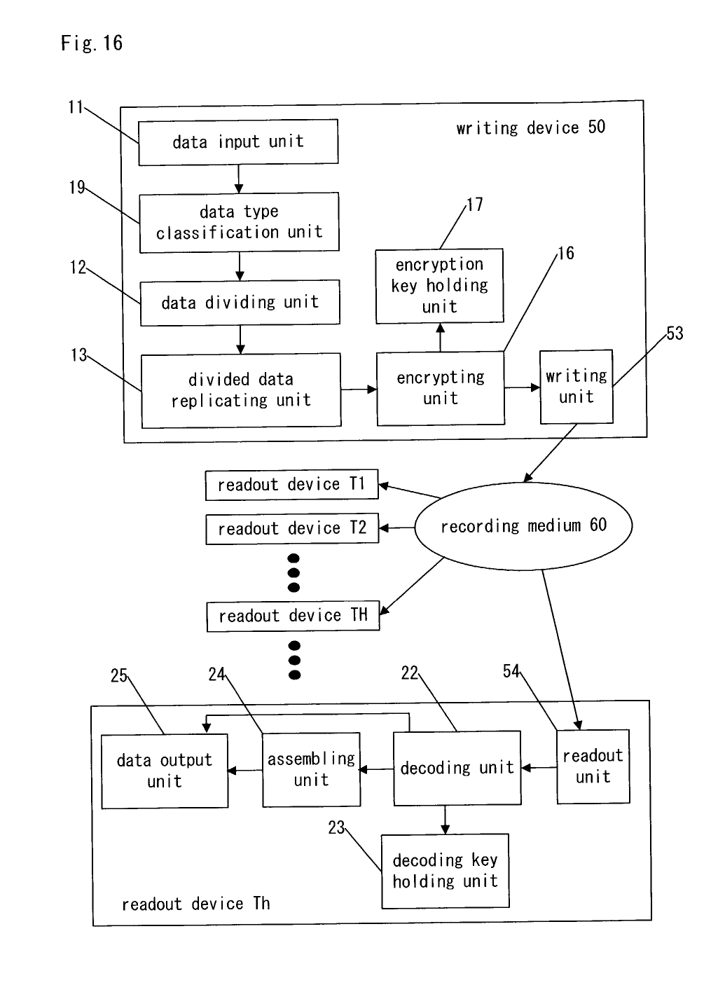

FIG. 16 is a block diagram of an exemplary data write and readout system in Embodiment 4 of the present invention.

As shown in FIG. 16, this data write and readout system is composed of a writing device 50 and readout devices T1, T2, . . . , TH . . . (collectively referred to as “Th”).

This writing device 50 is provided with a writing unit 53 in place of the sending unit 18 of the sending device 1 of FIG. 1 showing Embodiment 1. Therefore, other configurations are the same as the sending device 1 of FIG. 1, and an explanation thereof is omitted.

Furthermore, this readout device Th is provided with a readout unit 54 in place of the receiving unit 21 of the receiving device Rh of FIG. 1 in Embodiment 1. Therefore, other configurations are the same as the receiving device Rh of FIG. 1, and an explanation thereof is omitted.

Furthermore, the writing unit 53 of the writing device 50 writes the encrypted data prepared by the encrypting unit 16 on the recording medium 60. As an example of the recording medium 60, a CD (compact disc), a DVD (digital video disc) or the like can be given.

Furthermore, the flow of processing in the writing device 50 is the same as the flow of processing in the sending device 1 shown in FIG. 2.

Furthermore, the readout unit 54 of the readout device Th reads out the data written by the writing unit 53 which is recorded on the recording medium 60. Then, the readout unit 54 outputs the readout data to the decoding unit 22.

Furthermore, the flow of processing in the readout device Th is the same as the flow of processing in the receiving device Rh shown in FIG. 3.

Furthermore, as has been described above, in the embodiment, the data input by the data input unit 11 of the writing device 50 is subjected to dividing processing by the data dividing unit 12 and replication processing by the divided data replicating unit 13. Subsequently, the data is encrypted by the encrypting unit 16, and is written on the recording medium 60 by the writing unit 53.

As a consequence, the same data can be subjected to encryption processing with different encryption keys for each of the readout devices for reading-out the data while suppressing an increase of the load of encryption processing and an increase in the volume of the data to be recorded on the recording medium 60.

(Embodiment 5)

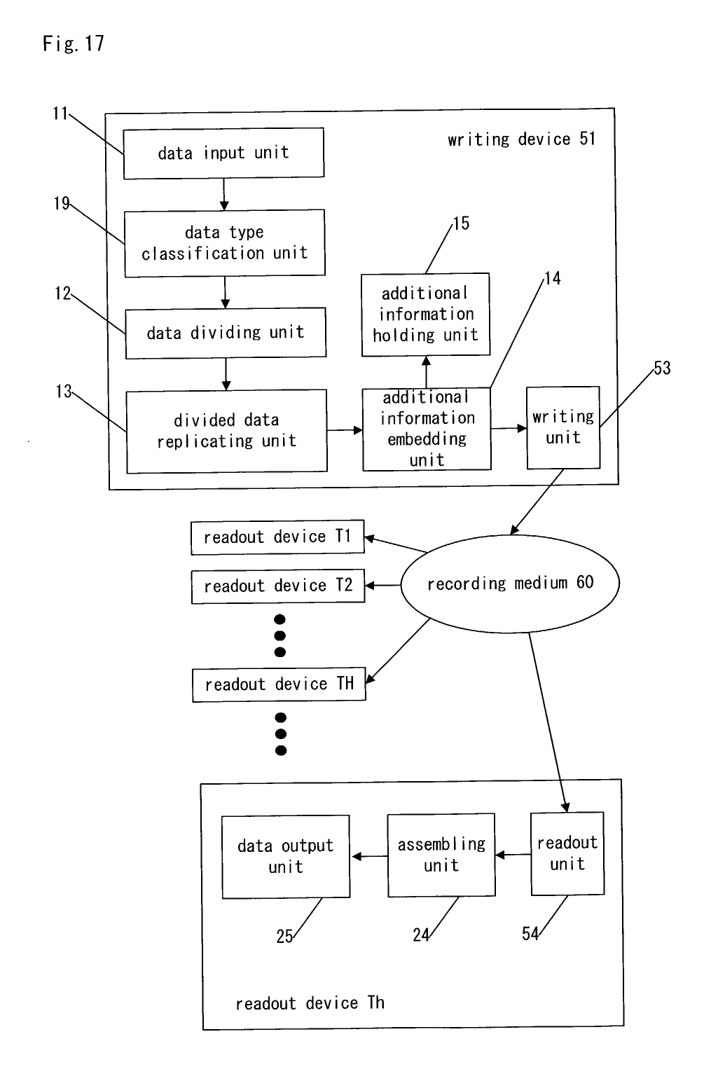

FIG. 17 is a block diagram of an exemplary data write and readout system in Embodiment 5 of the present invention.

As shown in FIG. 17, this data write and readout system is composed of a writing device 51, and readout devices T1, T2, . . . TH, . . . (collectively referred to as “Th”)).

This writing device 51 is provided with a writing unit 53 in place of the sending unit 18 of the sending device 2 of FIG. 4 in Embodiment 2. Therefore, other configurations are the same as the sending device 2 of FIG. 4, and an explanation thereof is omitted.

Furthermore, this readout device Th is provided with a readout unit 54 in place of the receiving unit 21 of the receiving device Rh of FIG. 4 in Embodiment 2. Therefore, other configurations are the same as the receiving device Rh of FIG. 4, and an explanation thereof is omitted.

Furthermore, the writing unit 53 of the writing device 51 writes the additional information embedded data prepared by the additional information embedding unit 14 on the recording medium 60. As an example of the recording medium 60, a CD (compact disc), and a DVD (digital video disc) or the like can be given.

Furthermore, the flow of processing in the writing device 51 is the same as the flow of processing in the sending device 2 shown in FIG. 5.

Furthermore, the readout unit 54 of the readout device Th reads out the data written by the writing unit 53 which is recorded on the recording medium 60. Then, the readout unit 54 outputs the readout data to the assembling unit 24.

Furthermore, as has been described above, in the present embodiment, the data input by the data input unit 11 of the writing device 51 is subjected to dividing processing by the data dividing unit 12 and replication processing by the divided data replicating unit 13. Subsequently, the data is embedded with the additional information by the additional information embedding unit 14, and is written on the recording medium 60 with the writing unit 53.

As a consequence, different pieces of additional information can be embedded into the same data for each of the readout devices for reading-out the data while suppressing an increase of the load of embedding processing of additional information and an increase in the volume of the data which is recorded on the recording medium 60.

(Embodiment 6)

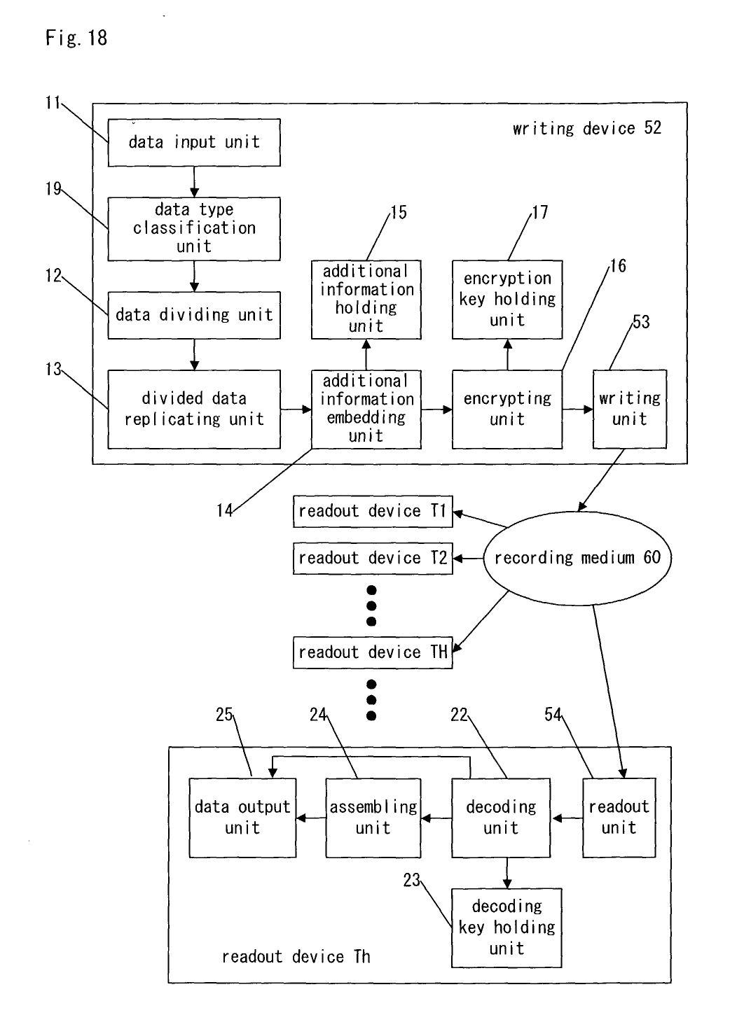

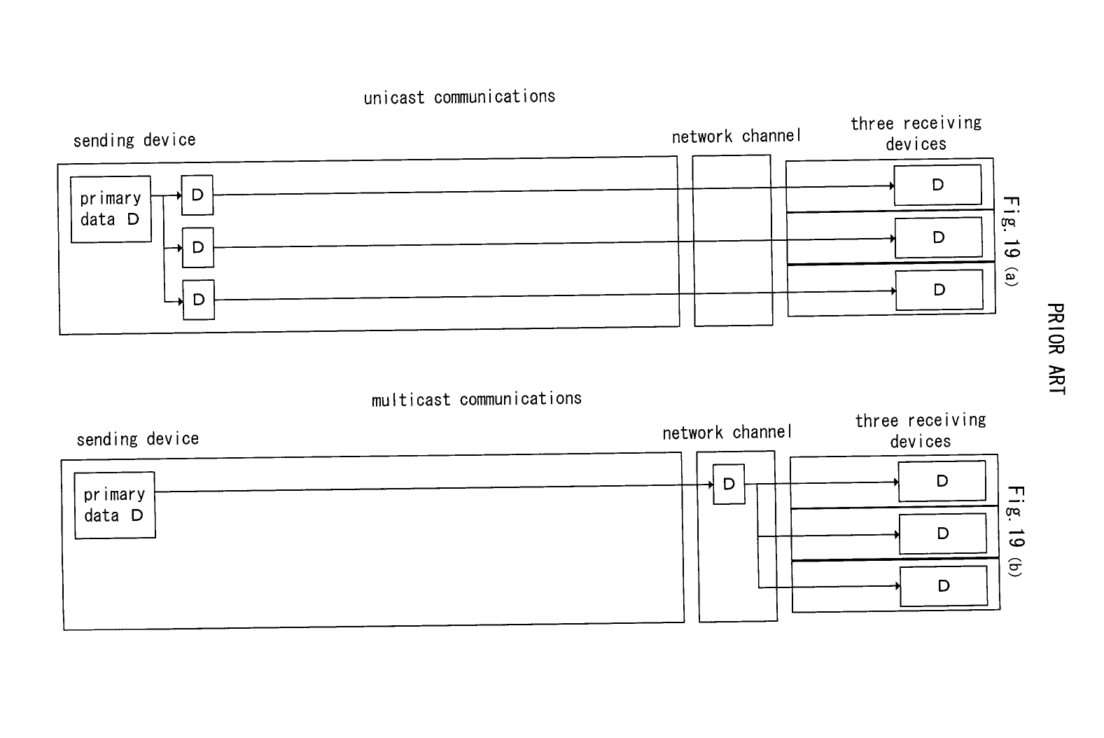

FIG. 18 is a block diagram of an exemplary data write and readout system in Embodiment 6 of the present invention.

As shown in FIG. 18, this data write and readout system is composed of a writing device 52 and readout devices T1, T2, . . . TH, . . . (collectively referred to as “Th”).

This writing device 52 is provided with the writing unit 53 in place of the sending unit 18 of the sending device 3 of FIG. 6 in Embodiment 3. Therefore, other configurations are the same as the sending device 3 of FIG. 6, and an explanation thereof is omitted.

Furthermore, this readout device Th is provided with a readout unit 54 in place of the receiving unit 21 of the receiving device Rh of FIG. 6 in Embodiment 3. Therefore, other configurations are the same as the receiving device Rh of FIG. 6, and an explanation thereof is omitted.

Furthermore, the writing unit 53 of the writing device 52 writes the encrypted data prepared by the encrypting unit 16 on the recording medium 60. As an example of the recording medium 60, a CD (compact disc), a DVD (digital video disc) or the like can be given.

Furthermore, the flow of processing in the writing device 52 is the same as the flow of processing in the sending device 3 shown in FIG. 7.

Furthermore, the readout unit 54 of the readout device Th reads out the data written by the writing unit 53 which is recorded on the recording medium 60. Then, the readout unit 54 outputs the readout data to the decoding unit 22.

Furthermore, the flow of processing in the readout device Th is the same as the flow of processing in the receiving device Rh shown in FIG. 3.

Furthermore, as described above, in the present embodiment, the data input from the data input unit 11 of the writing device 52 is subjected to is dividing processing by the data dividing unit 12 and is replication processing by the divided data replicating unit 13. Subsequently, the data is subjected to additional information embedding processing by the additional information embedding unit 14 and encryption processing by the encrypting unit 16 and is written on the recording medium 60 by the writing unit 53.

As a consequence, the same data can be subjected to embedding processing of different pieces of additional information and encryption processing with different encryption keys for each of the readout devices for reading-out the data while suppressing an increase of the load of embedding processing of additional information and encryption processing and an increase in the volume of the data which is recorded on the recording medium 60.

Having described preferred embodiments of the invention with reference to the accompanying drawings, it is to be understood that the invention is not limited to those precise embodiments, and that various changes and modifications may be effected therein by one skilled in the art without departing from the scope or spirit of the invention as defined in the appended claims.

What is claimed is:

1. A data distribution system having a sending device for distributing data by means of broadcast communications or multicast communications by using a network, and a plurality of receiving devices for receiving the data distributed by said sending device: wherein
said sending device comprises;
a data dividing unit for dividing input data into a plurality of pieces,
a divided data replication unit for replicating data divided by said data dividing unit,
an encrypting unit for encrypting a plurality of pieces of the same data including data replicated by said divided data replication unit, and
a sending unit for sending the data encrypted by said encrypting unit to the network; and
wherein each of said receiving devices comprises;
a receiving unit for receiving the data sent by said sending unit to the network,
a decoding unit for decoding the data received by said receiving unit, and
an assembling unit for assembling the data decoded by said decoding unit.

2. A data distribution system having a sending device for distributing data by means of broadcast communications or multicast communications by using a network, and a plurality of receiving devices for receiving the data distributed by said sending device:
said sending device comprises;
a data dividing unit for dividing input data into a plurality of pieces,
a divided data replication unit for replicating data divided by said data dividing unit,
an additional information embedding unit for embedding different pieces of additional information into a plurality of pieces of the same data including data replicated by said divided data replicating unit, and
a sending unit for sending the data embedded with the additional information by said additional information embedding unit to the network;
each of said receiving devices comprises;
a receiving unit for receiving the data sent by said sending unit to the network, and
an assembling unit for assembling the data received by said receiving unit.

3. A data distribution system having a sending device for distributing data by means of broadcast communications or multicast communications by using a network, and a plurality of receiving devices for receiving the data distributed by said sending device: wherein
said sending device comprises;
a data dividing unit for dividing input data into a plurality of pieces,
a divided data replication unit for replicating data divided by said data dividing unit,
an additional information embedding unit for embedding different pieces of additional information into a plurality of pieces of the same data including data replicated by said divided data replicating unit,
an encrypting unit for encrypting the data embedded with the additional information by said additional information embedding unit, and
a sending unit for sending the data encrypted by said encrypting unit to the network;
each of said receiving devices comprises;
a receiving unit for receiving the data sent by said sending unit to the network,
a decoding unit for decoding the data received by said receiving unit, and
an assembling unit for assembling the data decoded by said decoding unit.

4. A sending device for distributing data by means of broadcast communications or multicast communications comprises:
a data dividing unit for dividing input data into a plurality of pieces;
a divided data replication unit for replicating data divided by said data dividing unit,
an encrypting unit for encrypting a plurality of pieces of the same data including data replicated by said divided data replication unit; and
a sending unit for sending the data encrypted by said encrypting unit.

5. A sending device for distributing data by means of broadcast communications or multicast communications, comprises:
a data dividing unit for dividing input data into a plurality of pieces;
a divided data replication unit for replicating data divided by said data dividing unit,
an additional information embedding unit for embedding different pieces of additional information into a plurality of pieces of the same data including data replicated by said divided data replicating unit, and
a sending unit for sending the data embedded with the additional information by said additional information embedding unit.

6. A sending device for distributing data by means of broadcast communications or multicast communications, comprises:
a data dividing unit for dividing input data into a plurality of pieces;
a divided data replication unit for replicating data divided by said data dividing unit,
an additional information embedding unit for embedding different pieces of additional information into a plurality of pieces of the same data including data replicated by said divided data replicating unit,
an encrypting unit for encrypting the data embedded with the additional information by said additional information embedding unit; and
a sending unit for sending the data encrypted by said encrypting unit.

7. The sending device according to claim 4, further comprising a data type classification unit for classifying a plurality of types of input data into types and outputting the data of a predetermined type to said data dividing unit.

8. The sending device according to claim 5, further comprising a data type classification unit for classifying a plurality of types of input data into types and outputting the data of a predetermined type to said data dividing unit.

9. The sending device according to claim 6, further comprising a data type classification unit for classifying a plurality of types of input data into types and outputting the data of a predetermined type to the data dividing unit.

10. A receiving device for receiving data which has been subjected to dividing processing, replication processing and encryption processing and distributed, comprises:
a receiving unit for receiving the data;
a decoding unit for decoding the data received by said receiving unit; and
an assembling unit for assembling the data decoded by said decoding unit.

11. A receiving device for receiving data which has been subjected to dividing processing, replication processing and additional information embedding processing and distributed, comprises:
a receiving unit for receiving the data; and
an assembling unit for assembling the data received by said receiving unit.

12. A receiving device for receiving data which has been subjected to dividing processing, replication processing, additional information embedding processing and encryption processing and distributed, comprises:
a receiving unit for receiving the data;
a decoding unit for decoding the data received by said receiving unit; and
an assembling unit for assembling the data decoded by said decoding unit.

13. A data distribution method for distributing data by means of broadcast communications or multicast communications by using a network, comprising steps of:
dividing input data into a plurality of pieces;
replicating divided data;
encrypting a plurality of pieces of the same data including replicated data;
sending the encrypted data to the network;
receiving the data which is sent to the network;
decoding the received data; and
assembling the decoded data.

14. A data distribution method for distributing data by means of broadcast communications or multicast communications by using a network, comprising steps of:
dividing input data into a plurality of pieces;
replicating divided data;
embedding different pieces of additional information into a plurality of pieces of the same data including replicated data;
sending the data embedded with the additional information to the network;
receiving the data which is sent to the network; and
assembling the received data.

15. A data distribution method for distributing data by means of broadcast communications or multicast communications by using a network, comprising steps of:
dividing input data into a plurality of pieces;
replicating divided data;
embedding different pieces of additional information to a plurality of pieces of the same data including replicated data;
encrypting the data embedded with the additional information;
sending the encrypted data to the network;
receiving the data which is sent to the network;
decoding the received data; and
assembling the decoded data.

16. A sending method for distributing data by means of broadcast communications or multicast communications, comprising steps of:
dividing input data into a plurality of pieces;
replicating divided data;
encrypting a plurality of pieces of the same data including replicated data; and
sending the encrypted data.

17. A sending method for distributing data by means of broadcast communications or multicast communications, comprising steps of:
dividing input data into a plurality of pieces;
replicating divided data;
embedding different pieces of additional information into a plurality of pieces of the same data including replicated data; and
sending the data embedded with the additional information.

18. A sending method for distributing data by means of broadcast communications or multicast communications, comprising steps of:
dividing input data into a plurality of pieces;
replicating divided data;
embedding different pieces of additional information into a plurality of pieces of the same data including replicated data;
encrypting the data embedded with the additional information; and
sending the encrypted data.

19. The sending method according to claim 16, including a step of classifying a plurality of types of input data into types;
wherein the data of a predetermined type is divided into a plurality of pieces at the step for dividing the input data into a plurality of pieces.

20. The sending method according to claim 17, including a step of classifying a plurality of types of input data into types;
wherein the data of a predetermined type is divided into a plurality of pieces at the step for dividing the input data into a plurality of pieces.

21. The sending method according to claim 18, including a step of classifying a plurality of types of input data into types;
wherein the data of a predetermined type is divided into a plurality of pieces at the step for dividing the input data into a plurality of pieces.

22. A method for receiving data which has been subjected to dividing processing, replication processing and encryption processing and distributed, comprising steps of:
receiving the data;
decoding the received data; and
assembling the decoded data.

23. A method for receiving data which has been subjected to dividing processing, replication processing and additional information embedding processing and distributed, comprising steps of:
receiving the data; and
assembling the received data.

24. A method for receiving data which has been subjected to dividing processing, replication processing, additional information embedding processing and encryption processing and distributed, comprising steps of:
receiving the data;
decoding the received data; and
assembling the decoded data.

25. A recording medium computer readable, wherein a data preparation program is recorded which includes steps of:
allowing a data dividing unit to divide input data into a plurality of pieces;
allowing a divided data replication unit to replicate data divided by said data dividing unit
allowing an encrypting unit to encrypt a plurality of pieces of the same data including data replicated by said divided data replication unit.

26. A recording medium computer readable, wherein a data preparation program is recorded which includes steps of:
allowing a data dividing unit to divide input data into a plurality of pieces;
allowing a divided data replication unit to replicate data divided by said data dividing unit; and
allowing an additional information embedding unit to embed different pieces of additional information into a plurality of pieces of the same data including data replicated by said divided data replication unit.

27. A recording medium which is computer readable, wherein a data preparation program is recorded which includes steps of:
allowing a data dividing unit to divide input data into a plurality of pieces;
allowing a divided data replication unit to replicate data divided by said data dividing unit;
allowing an additional information embedding unit to embed different pieces of additional information into a plurality of pieces of the same data including data replicated by said divided data replication unit; and
allowing an encrypting unit to encrypt the data embedded with the additional information by said additional information embedding unit.

28. A recording medium which is computer readable, wherein a data assembling program is recorded for assembling data which has been subjected to dividing processing, replication processing and encryption processing and distributed which includes steps of:
allowing a decoding unit to decode the received data; and
allowing an assembling unit to assemble the decoded data.

29. A recording medium which is computer readable, wherein a data assembling program is recorded for assembling data which has been subjected to dividing processing, replication processing and additional information embedding processing and distributed which includes step of: allowing an assembling unit to assemble the received data.

30. A recording medium which is computer readable, wherein a data assembling program is recorded for assembling data which has been subjected to dividing processing, replication processing, additional information embedding processing and encryption processing and distributed which includes steps of:
allowing a decoding unit to decode the received data; and
allowing an assembling unit to assemble the decoded data.
